(19) United States
(12) Patent Application Publication
(10) Pub. No.: US 2021/0027901 A1
(43) Pub. Date: Jan. 28, 2021

(54) METHODS AND SYSTEMS FOR FACILITATING THE MANAGEMENT OF REACTOR TRANSIENT CONDITIONS ASSOCIATED WITH REACTORS

(71) Applicant: Robert Henry, Naperville, IL (US)

(72) Inventor: Robert Henry, Naperville, IL (US)

(21) Appl. No.: 16/684,403

(22) Filed: Nov. 14, 2019

Related U.S. Application Data
(60) Provisional application No. 62/879,299, filed on Jul. 26, 2019.

(51) Int. Cl. G21D 3/00; G21C 7/36; G21D 3/12

(52) U.S. Cl. CPC G21D 3/001; G21D 3/12; G21C 7/36

(57) ABSTRACT

Disclosed herein is a method of facilitating the management of reactor transient conditions associated with reactors. Accordingly, the method may include a step of receiving reactor data associated with a reactor from a reactor computer. Further, the method may include a step of determining a reactor transient condition associated with the reactor based on the reactor data. Further, the method may include a step of receiving reactor design data and measurement data associated with a plurality of reactor components of the reactor from the reactor computer. Further, the method may include a step of analyzing the reactor design data and the reactor measurement data. Further, the method may include a step of generating a notification corresponding to the reactor transient condition based on the analyzing. Further, the method may include a step of transmitting the notification to a user device associated with a user.

### FIELD OF THE INVENTION

Generally, the present disclosure relates to the field of data processing. More specifically, the present disclosure relates to methods and systems for facilitating the management of reactor transient conditions associated with reactors

### BACKGROUND OF THE INVENTION

Existing techniques for facilitating the management of reactor transient conditions associated with reactor are deficient with regard to several aspects. For instance, current technologies do not analyze reactor data in real-time following a reactor transient condition (dynamic operating transient). Furthermore, current technologies do not generate evaluations following the reactor transient condition. Moreover, current technologies do not communicate and distribute evaluations to reactor personnel. Further, current technologies do not provide confirmatory information regarding the reactor transient conditions. Further, current technologies do not provide recommended action corresponding to the reactor following the reactor transient condition.

Therefore, there is a need for improved methods, systems, apparatuses and devices for facilitating the management of reactor transient conditions associated with reactors that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating the management of reactor transient conditions associated with reactors, in accordance with some embodiments. Accordingly, the method may include a step of receiving, using a communication device, at least one reactor data associated with a reactor from a reactor computer. Further, the method may include a step of determining, using a processing device, at least one reactor transient condition associated with the reactor based on the at least one reactor data. Further, the method may include a step of receiving, using the communication device, a plurality of reactor design data and a plurality of reactor measurement data associated with a plurality of reactor components of the reactor from the reactor computer. Further, the method may include a step of analyzing, using the processing device, the plurality of reactor design data and the plurality of reactor measurement data. Further, the method may include a step of generating, using the processing device, at least one notification corresponding to the at least one reactor transient condition based on the analyzing. Further, the method may include a step of transmitting, using the communication device, the at least one notification to at least one user device associated with at least one user.

Further, disclosed herein is a method of facilitating the management of reactor transient conditions associated with reactors, in accordance with some embodiments. Accordingly, the method may include a step of receiving, using a communication device, at least one reactor data associated with a reactor from a reactor computer. Further, the method may include a step of determining, using a processing device, at least one reactor transient condition associated with the reactor based on the at least one reactor data. Further, the method may include a step of analyzing, using the processing device, the at least one transient condition. Further, the method may include a step of identifying, using the processing device, at least one reactor component of the plurality of the reactor components based on the analyzing. Further, the method may include a step of receiving, using the communication device, at least one reactor design data and at least one reactor measurement data corresponding to the at least one reactor component. Further, the method may include a step of evaluating, using the processing device, the at least one reactor design data and the at least one reactor measurement data. Further, the method may include a step of generating, using the processing device, at least one notification corresponding to the at least one reactor transient condition based on the evaluation. Further, the method may include a step of transmitting, using the communication device, at least one notification to at least one user device associated with at least one user.

Further disclosed herein is a system for facilitating the management of reactor transient conditions associated with reactors, in accordance with some embodiments. Accordingly, the system may include a communication device communicatively coupled with a reactor computer associated with a reactor. Further, the communication device may be configured for receiving at least one reactor data associated with the reactor from the reactor computer. Further, the communication device may be configured for receiving a plurality of reactor design data and a plurality of reactor measurement data associated with a plurality of reactor components of the reactor from the reactor computer. Further, the communication device may be configured for transmitting at least one notification to at least one user device associated with at least one user. Further, the system may include a processing device configured for determining at least one reactor transient condition associated with the reactor based on the at least one reactor data. Further, the processing device may be configured for analyzing the plurality of reactor design data and the plurality of reactor measurement data. Further, the processing device may be configured for generating the at least one notification corresponding to the at least one reactor transient condition based on the analyzing.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system configured for the management of reactor transient conditions associated with reactors, in accordance with some embodiments.

FIG. 3 is a flowchart of a method for facilitating the management of reactor transient conditions associated with reactors, in accordance with some embodiments.

FIG. 4 is a flowchart of a method for facilitating identification of reactor component based on analyzing transient condition, in accordance with some embodiments FIG. 5 is a flowchart of a method for facilitating the generation of confirmation data corresponding to the reactor transient condition, in accordance with some embodiments.

FIG. 6 is a flowchart of a method for facilitating the generation of remedial action corresponding to the reactor transient condition, in accordance with some embodiments.

FIG. 7 is a flowchart of a method for facilitating analyzing of reactor design data, reactor measurement data, and manual entry, in accordance with some embodiments.

FIG. 8 is a flowchart of a method for facilitating the generation of variable projection corresponding to the reactor transient condition, in accordance with some embodiments.

FIG. 9 is a flowchart of a method for facilitating the generation of an alert, in accordance with some embodiments.

FIG. 10 is a flowchart of a method for facilitating the generation of projection corresponding to the reactor transient condition, in accordance with some embodiments.

FIG. 11 is a flowchart of a method for facilitating the management of reactor transient conditions associated with reactors, in accordance with some embodiments.

FIG. 12 is a flowchart of a method for facilitating the generation of confirmatory data corresponding to the reactor transient condition, in accordance with some embodiments.

FIG. 13 is a flowchart of a method for facilitating the generation of remedial action corresponding to the reactor transient condition, in accordance with some embodiments.

FIG. 14 is a perspective view of the containment building, in accordance with prior art.

FIG. 15 is a flow diagram of operations for engineering modules, decision module 1514 and evaluation module, in accordance with some embodiments.

FIG. 16 is a block diagram of submodules of Reactor Coolant System (RCS) and Pressurizer (PZR), in accordance with some embodiments.

FIG. 17 is a block diagram of submodules of the containment module, in accordance with some embodiments.

FIG. 18 is a graphical representation showing the comparison of the Average Core Void Fraction (α) from the SRM signal using the approach discussed by Hooker and Popper (1958) with the boil-down of the TMI-2 core water level, in accordance with some embodiments.

FIG. 19 is a schematic of core degradation in the Phebus in reactor experiments and the flow of steam through and around the core, in accordance with some embodiments.

FIG. 20 is a graphical representation of measured hydrogen generation for three Phebus experiments and the comparison of measured late phase generation rate with the Countercurrent Flow Late Stage (CCFLS) Model, in accordance with some embodiments.

FIG. 21 is a graphical representation of measured steam voids in the core and Reactor Coolant System (RCS) for the TMI-2 Event, in accordance with some embodiments.

FIG. 22 is a graphical representation of a comparison of the TMI-2 pressurizer water level measurement and the calculation of the level swell needed for the PORV to vent a steam-water mixture, in accordance with some embodiments.

FIG. 23 is a graphical representation of a comparison of Reactor Coolant Drain Tank (RCDT) and Reactor Coolant System (RCS) Pressures and temperature compensated PZR water level histories for the TMI-2 accident along with the calculated RCDT history, in accordance with some embodiments.

FIG. 24 is a schematic of possible actions associated with decision block, in accordance with some embodiments.

FIG. 25 is a tabular representation of a TMI-2 pressurizer response immediately following a trip of the main feedwater pumps, in accordance with some embodiments.

FIG. 26 is a tabular representation of the comparison of measured and calculated tailpipe pipe temperatures for the TMI-2 accident, in accordance with some embodiments.

FIG. 27 is a tabular representation of timing of water depletion in a reactor core and the resulting overheating of fuel pins by decay heat and cladding oxidation, in accordance with some embodiments.

FIG. 28 is a block diagram of a computing device for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems facilitating the management of reactor transient conditions associated with reactors, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, comparing, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the one or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

1. The Purpose of RT-EVALS

The present disclosure may describe methods, systems, devices and apparatuses for facilitating the management of events associated with the power plants. Further, the system may analyze the key data as it is recorded by the plant computer, in real-time, for a commercial nuclear power plant following any dynamic operating transient, such as a reactor trip from full power. The goal of the analysis is to analyze the plant data as it is recorded to identify and confirm, on a real-time basis, if any condition develops that may challenge the reactor in any way and provide suggestions for remedial actions, again on a real-time basis. Further, the system may also be used to analyze transient plant conditions that could arise when the plant is in a shutdown condition for refueling or maintenance.

The present disclosure may describe RT-EVALS (Real-Time Evaluations). Further, the RT-EVALS may analyze key plant data (from the plant computer), in real-time, for a commercial nuclear power plant following any dynamic operating transient, such as a reactor trip from full power. Further, the evaluations of the plant response may be communicated to designated plant personnel outside of the main control room thereby providing a common, informed understanding supported by multiple levels of confirmatory information. Rapid distribution of this information to designated personnel simultaneously minimizes confusion and maximizes the understanding of the ongoing plant response. In addition, these evaluations are combined with recommendations of actions to be taken if needed. In a more general sense, RT-EVALS can also be used to monitor the system performance when the reactor has been shut down, and perhaps depressurized, for maintenance and/or refueling purposes where the available plant computer monitoring instrumentation may be reduced. The RT-EVALS assessments are accomplished through continuing analysis of the developing plant information/data with the essential feature being the development of confirmatory information that can be assembled through assessments of other independent plant measurements. Equally important, the RT-EVALS results may be displayed/observed on cell phones or computer tablets that are authorized for plant management and operating personnel.

Further, the RT-EVALS assessments of the plant responses, combined with the depth of confirmation from independent system data, directly assist the plant management and operating personnel in several ways during any plant upset conditions. Further, a common understanding of the ongoing plant responses which minimizes (or eliminates) confusion associated with the understanding/interpretation of individual system behaviors thereby reducing the need for extensive, repeated inter-personnel communications regarding the status of individual systems and/or components. Further, the dynamic interpretation of the developing individual measurements and the application of the resulting insights to central concerns during the ongoing event is an essential feature. RT-EVALS is applicable to Pressurized Water Reactor (PWR) designs. Further, the system may provide a confirmation for an indication that a Reactor Coolant System (RCS) pressure boundary failure may have caused the plant transient or has been compromised as a result of the plant transient. Further, the system may provide a confirmation for an indication that a steam void may be formed within the RCS. Further, the system may provide confirmation of the development of an RCS steam void to a size that may challenge sustained cooling for the reactor core, such as an uncovering of part of the reactor core. Further, the system may provide a confirmation for an indication that the containment boundary has been, or may be compromised as a result of the evolving plant transient with the possible consequence that radioactive fission products may be released from the RCS and containment. Further, the RT-EVALS may continually access the measurements of key instrumentation from the plant computer and searches for (1) any challenge to the designed performance and (2) confirmatory indications from independent measurements to support decision-making related to the above listed central questions. Confirmation of indicated behaviors, or lack thereof, is vital information for plant management personnel and those staffing the Technical Support Center (TSC). Further, the confirmation of the principal concerns for the plant response, including sustained core cooling and heat removal, as well as containment integrity are examined by the RT-EVALS through several paths using multiple layers of the plant measurements, some of these use current measurements in innovative ways to assess the status of the core and the RCS. Outputs of these confirmatory investigations are conveyed, along with the relevant data, to the individuals monitoring RT-EVALS to establish a uniform understanding of the ongoing response combined with the status of confirmatory information for each of the above central questions. Confirmation of suspected behavior is essential to addressing possible developing condition(s) that could present challenges to adequate core cooling and/or the integrities of the RCS and containment pressure boundaries.

2. Structure of the RT-EVALS

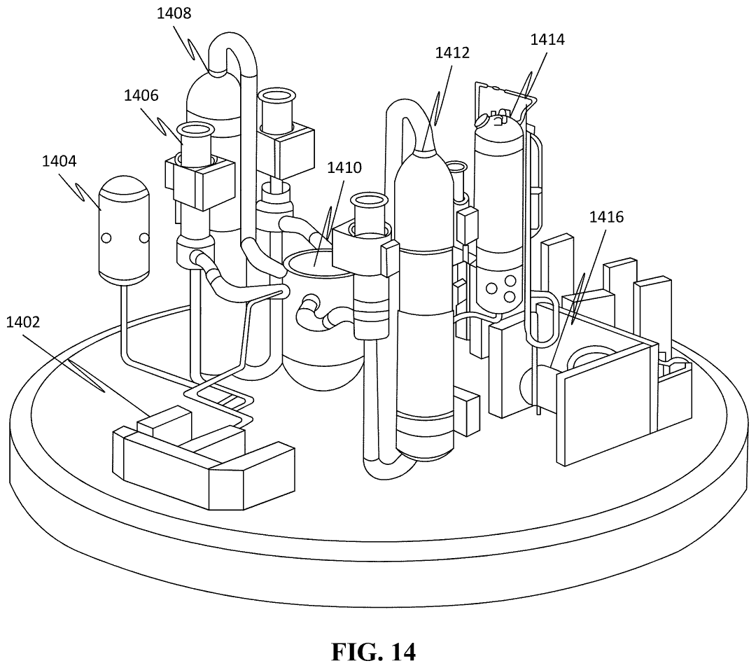

FIG. 14 illustrates the RCS configuration of the Three Mile Island Unit 2 (TMI-2) PWR which includes the reactor vessel [1410], the two (loops A [1412] and B [1408]) Once Through Steam Generators (OTSGs), the four Reactor Coolant Pumps (RCP-1A which is not shown due to a graphical cutout, RCP-2A, RCP-1B [1406] and RCP-2B), the four cold leg pipes extend from the bottoms of the OTSGs upward to the RCPs. The two candy cane-shaped hot legs extend from the reactor vessel to the respective OTSGs and the pressurizer (PZR) [1414] which also had safety relief valves as well as a Pilot Operated Relief Valve (PORV) at the top are also shown. While there are different PWR RCS designs, they all have these components and all designs have a large, leak-tight containment building that encases the RCS. To develop a complete overview of the system response, the RT-EVALS examines the behavior of each of these components once an operating transient occurs. FIG. 14 shows a cutaway of the lower part of the containment building and the location of the Reactor Coolant Drain Tank (RCDT) [1416] that is discussed with respect to the PZR and the containment.

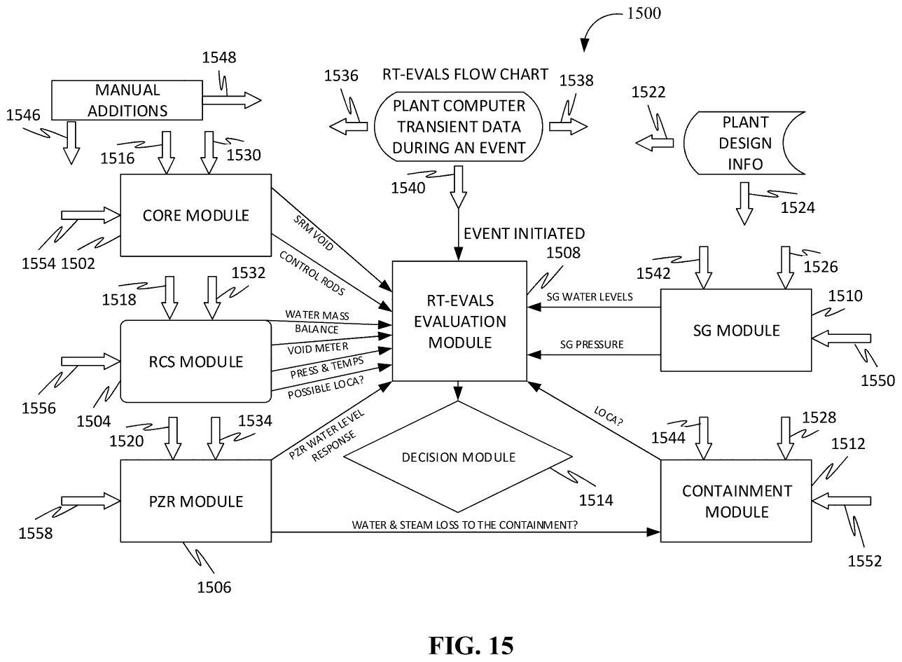

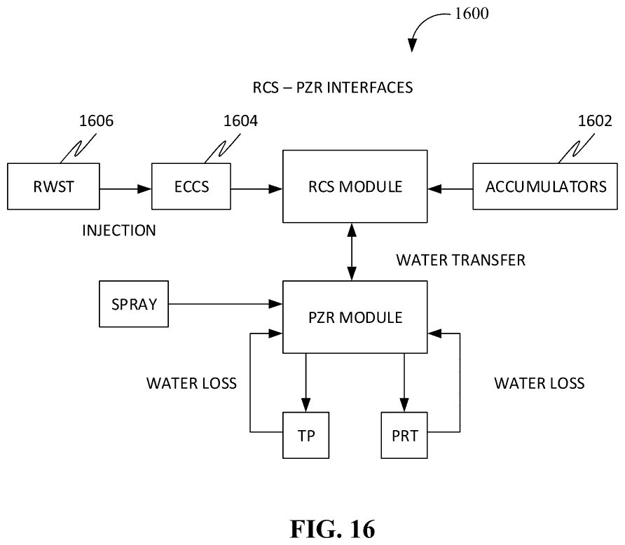

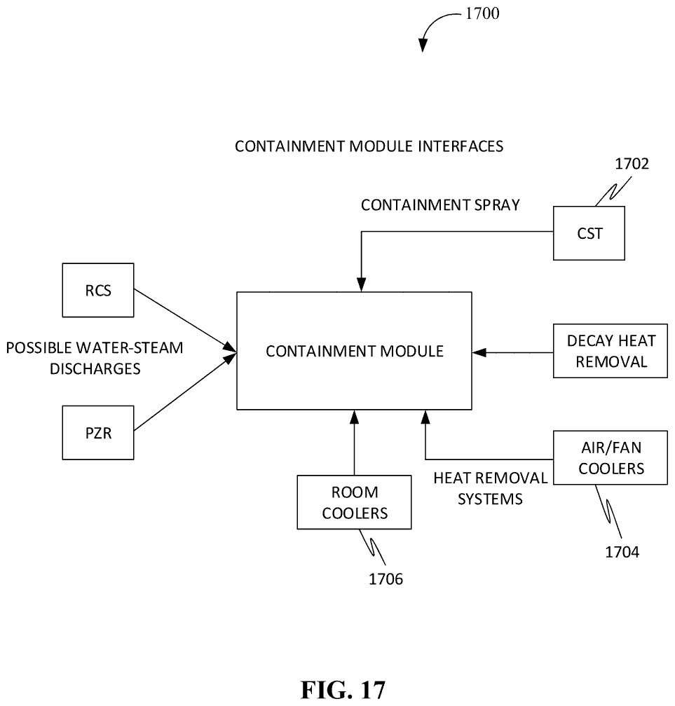

FIG. 15 illustrates the RT-EVALS overall structure with (i) the five Engineering Modules (Core, RCS, SGs, PZR and Containment), (ii) the essential Evaluation Module and (iii) the Decision Block. As shown, two major data sources are used: (a) the plant design information database (arrows 1516-1528 indicate its distribution) and (b) the plant computer measurements (arrows 1530-1544 show its distribution). FIG. 16 shows additional details related to the Pressurizer and RCS Modules, including the nitrogen pressurized water accumulators that are on each cold leg and Emergency Core Cooling Systems (ECCS) as well as the water injection systems that take suction from the Refueling Water Storage Tank (RWST) [1606] that may have a different name for specific plants, and FIG. 17 provides an expanded view of the Containment Module evaluations. Plant design information includes dimensions, designed pump flow rates, maximum power generation, or design energy removal rates, etc. Plant computer measurements are principally those transient responses recorded by the plant computer for the evolving plant transient. Values from the plant design file (1516-1528 arrows) define the plant as designed and operated that do not change during an event. Conversely, the data from the plant computer (1530-1544 arrows) would be changing during the event. It is these changing readings, along with the rates of change that are examined by the respective engineering modules and compared by the evaluation module as the event progresses that ensures the RT-EVALS has developed an understanding of the accident progression that is consistent with the data that has been accumulated by the plant computer. The methodology also provides a means of including information that may be recorded by another system, or manually recorded that are meaningful measurements for characterizing the transient behavior. This information is indicated by the 1546-1558 arrows and this data entry path provides a means of incorporating measurements that may only be used during maintenance activities and/or refueling. As with other measurements, this information must be added in terms of the time of day that the measurement was taken and the measured value corresponding to that time. Further, the system may include six modules. Further, the six modules may include the Reactor Core Engineering Module, the RCS Engineering Module, the SG Engineering Module, the Pressurizer (PZR) Engineering Module, the Containment Engineering Module, and the Evaluation Module. The Engineering Modules perform calculations that are associated with the internal assessments of the instrument readings (measurements) in the Reactor Core Engineering Module, the RCS Engineering Module, the SG Engineering Module, the Pressurizer (PZR) Engineering Module, the Containment Engineering Module. Relevant information regarding steam and water mass flow rates, energy transfer rates, RCS pressurization or depressurization rates, possible steam void formations in the RCS and the core, etc. These are then communicated to the Evaluation Module (#6) which compares the results calculated by the Engineering Modules and determines, in real-time, if there is a consistent explanation of the responses throughout the reactor and containment systems. The results of these comparisons are then communicated to the decision block. Distributing this system-wide information to plant management and operating personnel outside of the main control room would certainly minimize, and possibly eliminate the confusion that could be generated if one or more components experience failure or unusual operating behavior. Minimizing confusion maximizes the use of available resources which is the most central objective when the plant behavior takes an unforeseen path due to an event/accident sequence.

3. How RT-EVALS is Used

As noted previously, this “real-time” event/accident RT-EVALS is not intended to be used in the main control room, which already has well developed operating and emergency operating procedures. Rather, this real-time approach is a tool that can perform a composite system analysis along with a representation for the depth of confirmation in real-time and transfer this to computer tablets and/or cell phones to uniformly communicate the results of combined reactor system analyses to management and operating personnel who are outside of the main control room. These are personnel that have a need to know and understand the evolving plant behavior and the depth of confirmation obtained from the measurements. If there is something that needs to be communicated to the main control room, these persons are the ones to communicate that information along with the support of the real-time analysis. As noted above, the principal purpose is to provide a common understanding, in real-time with confirmation, of the ongoing plant response, through comparisons of the key plant measurements, in terms of the four central questions listed above. Specifically, are there any changes, or updates to the plant status or any measurements/indications related to the status, that call attention to possible long term challenges to the reactor core, RCS or containment integrities? Confirmation, or lack thereof, of such indications would be communicated by those monitoring the plant response through RT-EVALS. As noted above, any need to communicate this information to the main control room would be handled by the TSC personnel.

When structuring this real-time approach, it is essential that the lessons learned from plant operational transients, as well as those learned from nuclear power plant accidents like the Three Mile Island Unit 2 (TMI-2) and the Fukushima core damage accidents are specifically included and evaluated, where relevant. The TMI-2 reactor was a PWR with a large dry containment and the evolving event/accident provides a convenient example to highlight the importance of developing and supplying confirmatory information to plant personnel to eliminate/minimize confusion when somewhat surprising conditions are encountered. This event/accident was initiated by a Loss of Feedwater (LOF) event which caused the turbine to be isolated and the reactor scrammed. These necessary automatic actions caused a short term pressurization of the Reactor Coolant System (RCS) such that Power Operated Relief Valve (PORV) on the pressurizer opened, as designed, to enable venting of high-pressure steam for a short interval. However, contrary to the design, the PORV remained stuck in the open position when the RCS pressure decreased below the valve setpoint and this led to a sustained loss of coolant from the RCS into the containment.

The outer surface of the tailpipe (TP) connecting the PORV to the Reactor Coolant Drain Tank (RCDT) in the containment (for Westinghouse PWR designs this tank is designated the Pressurizer Relief Tank (PRT)) was instrumented with surface thermocouples to indicate/detect if there had been, or was a continuing steam, or steam-water mixture discharge through the tailpipe. However, the control room operators had not been given any specific guidance regarding the expected temperature readings if either a short term, or a continuing discharge were to occur. Considering the critical flow of a compressible fluid like steam or a steam-water mixture through the valve (Henry and Fauske, 1971) and the downstream expansion into the tailpipe, a continuing steam discharge through the PORV and into the tailpipe would result in a range of temperatures (approximately 212° F./100 C). Conversely, a sustained discharge of a flashing, steam-water mixture could produce higher temperatures (about 300° F./149 C). Had these temperature ranges been provided to the control room operators or the plant staff, they would have understood the meaning of the measured valve of 285 F. Unfortunately, since the measured water temperatures circulating in the RCS coolant loops was about 550° F., the operators assumed that the highest temperature reading of 285° F. was representative of the tailpipe experiencing a cool down following opening and closing of the valve. Because of this misinterpretation/confusion, the steam-water discharge continued for two hours and twenty-two minutes, and it led to the uncovering and overheating of the reactor core and eventually destruction of the nuclear fuel pins.

Pursuing this further, the RCDT pressure was increasing rapidly due the sustained discharge from the PORV, but the readout for this measurement was in an instrument cabinet in the back of the control room and not easily accessible to the operators, nor were they told to check this readout. However, if they had been instructed to look at these RCDT measurements, or if the pressurization had been conveyed to them in some manner, it would have confirmed that the relief valve was stuck open. If their colleagues outside the control room would have had an analytical tool that continually analyzed and compared the essential measurements, this condition would have been discovered early in the accident. With this understanding, the control room operators could have closed the block valve that was in series with the PORV and stopped the leak early in the event with no damage to the reactor core. (Since the operators were attempting to figure this out on their own, the stuck open valve was not discovered until much later into the accident).

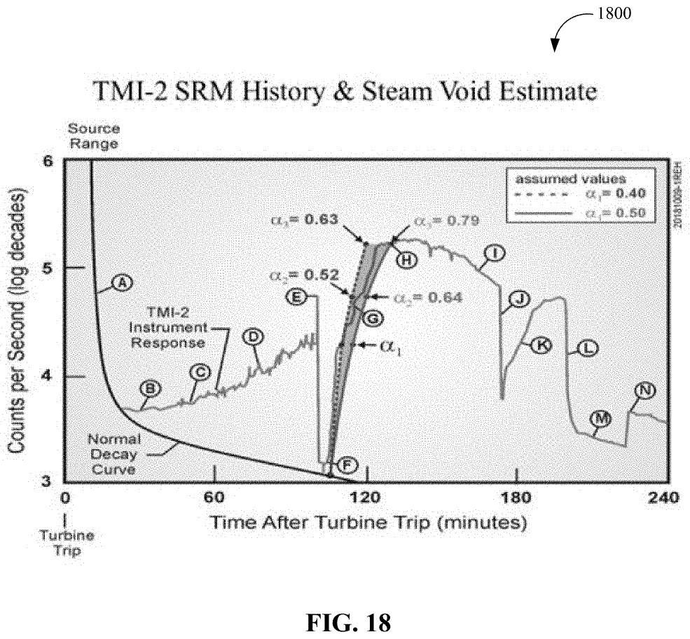

Digging deeper into the core measurements, a relevant example of a misinterpreted measurement from the TMI-2 accident (FIG. 18) involves the signal from one of the Source Range Monitors (SRMs) that was available to the operators on the main instrument panel of the control room. (The solid black line [A] is the expected decay behavior for the SRM once a reactor has been tripped. Point B [B] shows when the signal begins to depart from the expected behavior.) This occurs approximately 20 minutes after the turbine trip, the operators noticed that the SRM signal, which was expected to decrease monotonically, was observed to be increasing. Like the tailpipe temperature measurements, deviations of this nature from the expected response were not part of the operators training or experience. Therefore, it is not surprising that they perceived the increasing SRM reading as indicating a return to power of the reactor core, which was the heart of the confusion that was generated at this crucial time and occupied the operators for about hour during a crucial interval of the developing accident. While the control room operators' actions were with the best intentions, the reactor was not returning to power and over an hour of preciously needed time was lost on futile efforts to try and counter this perceived return to power. Steam formation in the core (and the RCS) was the reason that the SRM signal was increasing because there was less absorption of the neutrons and gamma rays produced in the core, hence the signal continued to increase as more water was lost from the RCS as shown by points [C] and [D]. (Point [D] is also the time when the “A” loop RCPs were stopped and point [E] is the time when “B” loops RCPs were stopped. However, the operators had not been provided with engineering calculations regarding those behaviors that could cause the SRM signal increase after the reactor had been scrammed and therefore this diverted their attention for an hour. This important feature of the core measurements is analyzed in real-time in the RT-EVALS by considering the extent of the steam void consistent with the signal increase (Hooker and Popper, 1958) and it shows a continually increasing steam void as discussed later.

Each of these illustrates the most insidious consequence of accident situations: confusion generated by (a) uncertainties in the interpretation of individual instruments, (b) the inability to rapidly check and confirm the available information through the response of other independent instruments and (c) the inability to quickly have realistic forward-looking projections based on the current plant status. Further, the system focuses on the spectrum of responses that could be generated by the evolving event/accident. Further, the system may focus on the status of the confirmatory information that is available. Furthermore, the system may provide the summarized confirmatory information in a timely manner to support the necessary decision-making process. Further, the system may facilitate the formulation of realistic, short turn around, near term projections of the event/accident based on the confirmed plant status if certain actions may be or may be not implemented.

Consequently, RT-EVALS is a real-time analytical tool that drives at the heart of possible areas where confusion could develop and prevents the confusion from occurring by communicating the extent of confirmation. This approach maximizes the use of available time and resources by always searching for confirmatory information and distributing this information promptly to those involved with plant management and the Technical Support Center (TSC). If there is information that needs to be communicated to the main control room, it should be by these individuals after they have reviewed the confirmatory analyses. Consequently, this tool provides a real-time evaluation along with a firm basis of using the currently available plant information to determine the event/accident behavior and then recommend corrective actions when needed.

4. The Information to be Supplied by the Plant Computer

Table 1 identifies some of the most important plant measurements to be examined by the engineering modules in assessing the individual PWR plant responses to possible transients, such as a reactor scram. Using the measured plant data, the RT-EVALS determines whether any of the measured information is trending outside the boundaries for the response to the initiating transient. When the identified condition(s) is(are) within the expected boundaries, the confirmatory measurements are evaluated with trends being noted but actions are not conveyed. However, if one or more measurements are/is trending toward, or is outside of the expected boundaries, the condition is identified and examined to see if other independent measurements confirm this observation. (An example is the SRM signal, shown in FIG. 18, which is expected to monotonically decrease following a scram. However, even noise in the signal could produce small variations in the signal as received from the plant computer that does not satisfy the expected trend. Therefore, the RT-EVALS notes any discrepancy and continues evaluated the trend to see if it continues over 10 cycles and then over 20 cycles of the computer output. Once a signal is verified to be outside of the expected boundary/boundaries, for example the SRM signal is demonstrated to be increasing, other signals are interrogated to determine if these confirm this behavior. Other examples of important signals could be the void fraction associated with the mass flow rate measurements on each coolant loop with an operating RCP/MCP, a measured effective core water level that is less than a full vessel height, or a measured core exit temperature that greatly exceeds the saturation temperature corresponding to the RCS pressure. If one or more of these are observed, RT-EVALS provides an assessment of the depth of confirmatory information along with estimates of time available before a challenge to core cooling could be anticipated. Once this has begun, the RT-EVALS continually assesses the situation, searches for confirmation where needed and assesses/recommends actions that could be taken.

### Table 1:

Example of the Data Needed from a PWR Plant Computer
Status of the control rods (fully inserted or not)
RCS and containment pressures
RCS and containment temperatures
Reactor core water level (Reactor Vessel Level Instrument System (RVLIS))
Core exit temperatures
RCS individual loop flow rate measurements
Energized or operating status of main circulation pumps (Reactor Coolant Pumps (RCPs) or Main Coolant Pumps (MCPs))
Steam generator (SG) water levels
SG feed water flow rates
SG auxiliary feedwater flow rates
Individual steam generator pressures
Individual status of the Main Steam Isolation Valves (MSIVs)
Isolation condenser water levels and pressures (where appropriate)
Containment sump water levels
High Radiation measurements and/or alarms for RCS, containment and adjacent plant buildings
Measurements from the core power instruments, especially the Source Range Monitors (SRMs)
Individual valve status for depressurizing the RCS (PORVs and RVs)
Individual valve status for the containment venting system(s)
Flow rates and temperature measurements for the Residual Heat Removal (RHR) systems
Status of the containment cooling systems (containment sprays that take suction from the Condensate Storage Tank (CST) and air/fan coolers) along with the measured flow rates and temperature differences.
Status of smaller individual cooling systems located within the containment along with the measured flow rates and temperature differences. If detailed flow rates and temperature differences are not available for these smaller systems, the design values can be used as reasonable estimates when the status of the systems (energized or not energized) are available. Measurements or systems status information can also be added manually by plant personnel.

5. The Plant Information and Plant Computer Instrumentation Used by the Engineering Modules

Each engineering module has specific inputs that are needed from the plant design information file and selected information from the plant computer. The major inputs influencing the individual calculations within each module are listed below.

5.1 Reactor Core Module

Plant Design Information
Maximum designed core operating power
Reactor nuclear fuel assembly dimensions and number of assemblies
Design dimensions for the water baffle and RPV downcomer regions

Plant Computer Measurements
Core power
Control rod positions
Water mass flow rate to the core
Core outlet temperature(s)
Source Range Monitor (SRM) readings
Reactor Vessel Level Instrument System (RVLIS) readings
Reactor Pressure Vessel (RPV) pressure
Core inlet water temperature

5.2 Reactor Coolant System (RCS) Module

Plant Design Information
Water volumes for all the RCS components (pumps, piping, SGs (tubes and plenums), accumulators and RPV)
Maximum mass flow rates through the RCS coolant loops
Design flow rates for all of the water injection systems

Plant Computer Measurements
System pressure
Hot leg and cold leg temperatures for each coolant loop
Mass flow rate measurements for each coolant loop
Individual water flow rates for all injections systems to the RCS
Gas pressures in all accumulators
Letdown water flow rate from the RCS

5.3 Steam Generator (SG) Module

Plant Design Information
Number of steam generators
Detailed SG design information

Plant Computer Measurements
Secondary side pressure for each SG
Feedwater and Auxiliary feedwater inlet temperatures for each SG
Feedwater and Auxiliary feedwater mass flow rates into each SG
Secondary side water level in each SG
Status of the Main Steam Isolation Valve (MSIV) for each SG
Radiation level in each SG and Main Steam Line (MSL)

5.4 Pressurizer (PZR) Module

Plant Design Information
Pressurizer vessel design details of height, diameter, etc.
Design details for the PZR surge line connecting to the RCS
Design information of the PZR water level measurement(s)
The design lifting pressures and mass discharge rates for the PORV(s) and Safety Valves (SVs)
The design details for the tailpipe connecting the PORV(s) and safety valves to the collection tank (PRT/RCDT) in the containment
The design details of the collection tank (PRT/RCDT) including the rupture disk size and pressure limit
Normal operating conditions for the pressurizer and the collection tank such as the water mass, water level, operating pressure, water temperature, etc.

Plant Computer Measurements
Pressurizer water level measurement
Pressurizer valve stem positions if available
Tailpipe temperatures if available
PRT/RCDT pressure and water temperature if available
Block valve position(s) if available

5.5 Containment Module

Plant Design Information
Open volume of all containment regions
Design Basis Accident (DBA) pressure for the containment structure
Design flow rate for the containment sprays and spray setpoints
Elevation of the containment spray header/headers for multiple spray trains
Number of containment air/fan coolers in the containment
Design value for the airflow rate through each containment air/fan cooler
Design values for any localized (room) coolers inside of the containment
Design values for any water pool that is part of the containment design basis (sumps, etc.) and design details on how this mass is connected to the other parts of the containment

Plant Computer Measurements
Containment pressure
Containment gas temperatures
Containment sump water level(s)
Containment sump water temperature(s)
Containment radiation levels
Containment spray actuation and mass flow rates from the CST
Compartment temperatures that contain a large water mass
Air/fan cooler volumetric flow rates through active coolers and the temperature differences across each cooling unit.
Cooling water flow rates and temperature increases across each air/fan cooling unit
Coolant flow rates and temperature difference across smaller, localized cooling units

6. The Role of Each Engineering Module

6.1 Reactor Core Module

This engineering module has several roles depending on the event and the possible event progression toward any severe (core damage) condition. For all event evaluations, this module continually assesses three major plant features.
1. Has the core nuclear fission reaction been shut down by the insertion of the control rods and/or boron injection to the core?
2. If the control rods are completely inserted and/or boron injection has occurred, are the SRM measurements showing the expected monotonic decrease for the neutron flux within the reactor core?
3. Do the core water level measurements (RVLIS and other if applicable) confirm the SRM measurements and do the core exit temperatures (where applicable) show temperatures that are more than 200 F (111° C.) above the saturation value corresponding to the RCS pressure?

If the core fission reaction has been shut down and if the SRM measurements demonstrate a monotonic decrease consistent with the decay curve from full power, the core is behaving as expected following a reactor trip and the core is covered and cooled by water. When this is the case, the only further analyses that would be performed by this module would be a survey of the measurements reported by the RVLIS and the core exit thermocouple(s). If these were to indicate values different than a core region full of water and core exit temperatures that are consistent with, or less than, the saturation temperature corresponding to the RCS pressure, then the evaluation module would examine the results from the other engineering modules to see if the RCS shows any indication of a steam void forming and whether the containment has observed steam addition to the building atmosphere.

However, there are two additional situations that may require further analyses should they occur. One of these involves an event response in which the plant instrumentation shows that some, or all control rods are not fully inserted. Moreover, if the SRM does not show the normal decay of the neutron flux within the first few minutes, then there is a possibility that there is an Anticipated Transient Without Scram (ATWS). This would trigger a specific set of Emergency Operating Procedures (EOPs) by the control room operators. These procedures dictate the control room operator actions, and the RT-EVALS should not be used until the core has demonstrated a shutdown behavior.

A second situation is like that which occurred during the TMI-2 accident where the reactor core nuclear fission was shown to be shut down by the fully inserted control rods and the SRM signal demonstrated the rapid decrease associated with a control rod insertion (reactor scram). About 30 minutes after the reactor scram, the SRM signal changed and began to increase. However, this was not caused by a return to fission power in the core! It was the result of a loss of water in the core region (formation of a steam void) which caused less absorption of the strong gamma rays and the delayed neutrons produced in the core. Using this lesson learned, if an event should result in a SRM measurement that eventually experiences a reversal in the monotonic decreasing signal, the Core Module evaluates this as a loss of water inventory from the core region and calculates the extent of a steam void that is forming in the core. FIG. 18 is a comparison of the TMI-2 SRM signal with the RT-EVALS calculations as the core is first covered at about 100 minutes when the MCPs are tripped and then uncovered again due to vaporization by decay heat. The increasing SRM signal is compared with representations using the radiation attenuation approach recommended by Hooker and Popper (1958) with the decreasing core water level calculated by the steam generated as a result of decay heat generated beneath the water level. As shown by the close comparison between the SRM measurement signal and the calculated behavior, if the reactor is scrammed, the core average steam void fraction can be closely estimated using the recorded SRM signal. Clearly, once a void is detected in the core, the RCS has lost some of its water inventory, which may be a Loss of Coolant Accident (LOCA). This estimated void fraction value is transmitted to the Evaluation Module where it is compared to the results of calculations from the RCS Module, the PZR Module and the Containment Module that could provide insights into where a LOCA site could exist as well as confirmation of steam formation in the RCS and/or an increase in the steam partial pressure in the containment. As noted above, the Core Module also examines the RVLIS measurement for additional confirmation of the steam void (this measurement was not part of the plant instrumentation for TMI-2).

If there is confirmation of a steam void forming within the core and the RCS, the core exit temperature measurement(s) is/are examined to determine if there is an indication of inadequate core cooling. Should an event progress to the point where the steam void would be sufficiently large to challenge core cooling, the Core Module estimates the time before the maximum core temperature could increase to the point where the Zircaloy cladding for the uranium fuel pellets could begin rapid, exothermic oxidation that could cause major core damage. For example, the rapidly rising SRM signal in FIG. 18 at about 100 minutes into the accident is consistent with an increasing steam void fraction in the core, At this time, the last RCPs were tripped so the steam-water mixture that was undergoing forced circulation through the RCS would now separate with the water collecting in the bottom of the RCS component where it resided at that time. However, since the RCPs are off, this void fraction in the reactor core initially decreased because much of the water collected in the bottom of the reactor vessel but it rapidly began increasing because the core water level was decreasing with the consequence being that the core exit temperatures were beginning to rise rapidly toward the stainless steel melting temperature. These are comparisons and analyses that would be conducted by the Core and RCS Engineering Modules so that the Evaluation Module can evaluate the results to assess the depth of confirmation regarding the evolving behavior.

Should an event evolve into inadequate core cooling and core overheating that achieves either measured or calculated core exit temperatures that exceed 1300 F (˜700 C), RT-EVALS will begin to assess the possible formation of hydrogen as a result of cladding oxidation in the steam environment that becomes significant at these temperatures.

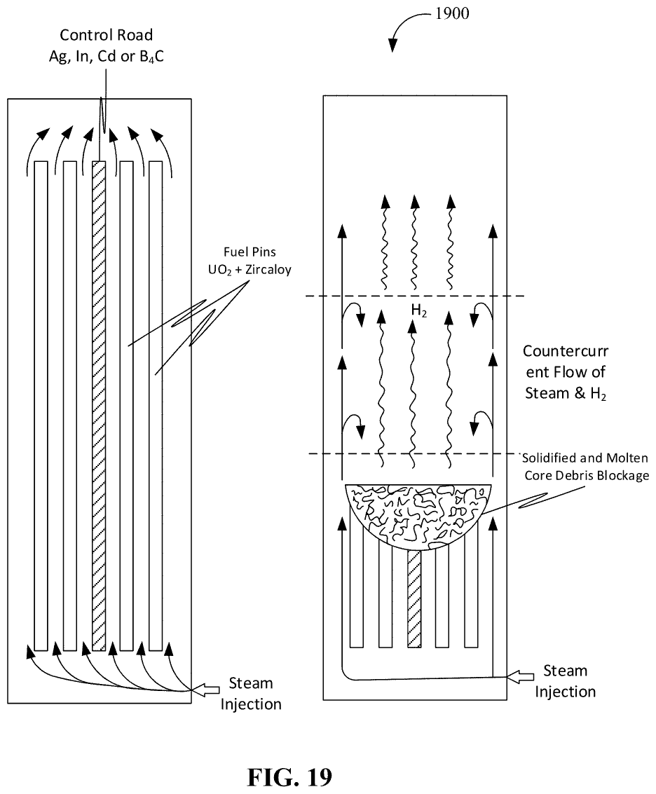

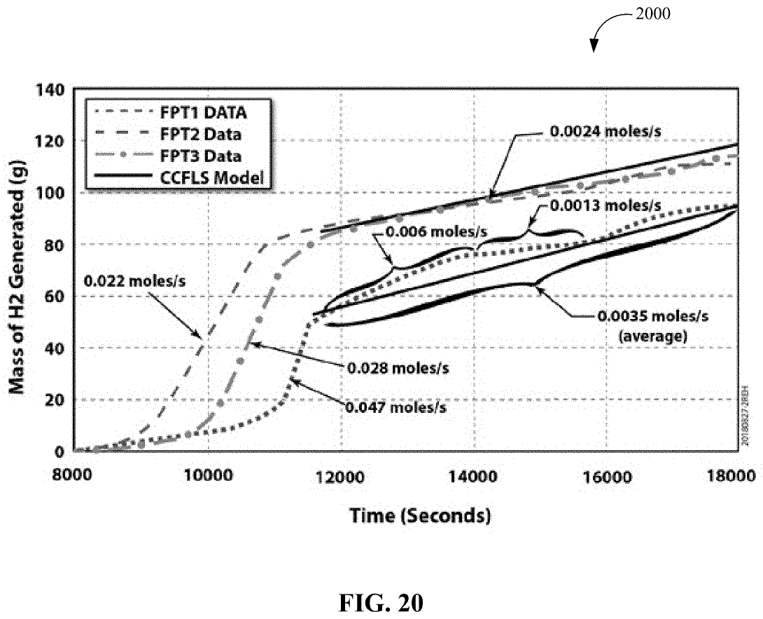

Fundamental calculations (EPRI, 1992) show that essentially the upper half of the core must be uncovered before the core exit temperatures reach the above levels. If this would occur, the exothermic oxidation reaction between the high temperature Zircaloy cladding and steam would generate a thermal excursion and eventually the local chemical energy release would eventually exceed the decay heat generated by the fuel. This rapid chemical reaction would continue increasing at greater rates until the fuel pin cladding would melt, liquefy the fuel pellets, drain into the lower core region and freeze. At this point, the relocated frozen core material would essentially block the steam flow through the core and begin to freeze in the lower, cooler core regions. As this frozen material collects it would greatly reduce the chemical reaction. This order of magnitude change in the core geometry (see FIG. 19) has been demonstrated by the three Phebus in-reactor experiments (Bourdon, et al, 2002, Di Giuli, et al, 2015 and Sangiorgi, et al, 2015) and the influence on the oxidation rates is an order of magnitude decrease (for example from about 0.022 to 0.0024 moles/sec) due to the compaction of the core as shown in FIG. 20.

Should an accident progress to this point, Henry (2019) has shown that the order of magnitude reduction in the oxidation for all three in-reactor Phebus experiments is consistent with oxidation of the remaining metals in the core from the core debris upper surface. Natural circulation of steam downward to the debris upper surface in conjunction with the upward flow of the hydrogen generated by the oxidation as illustrated by the Countercurrent Flow Late Stage model (CCFLS). Consulting FIG. 20, it is observed in all three tests that there is a maximum generation rate that characterizes the early phase of oxidation when the fuel pin geometry is intact. Subsequently, the rate of hydrogen generation suddenly decreases to a much slower rate that is well predicted by the natural circulation of steam downward to the debris upper surface shown by the continuous black lines that illustrate the results of the CCFLS model presented in the Henry (2019) reference. RT-EVALS uses this late stage model in the Core Module to assess the hydrogen generate that could persist during that late stage of an accident that would occur if a severe core damage event were to progress to the late stage.

6.2 Reactor Coolant System (RCS) Module

There are several RCS measurements that can be used to evaluate the event transient as it relates to the formation of a steam void in the RCS as well as long term cooling of the reactor core. These include the RCS system pressure, the cold leg and hot temperatures for the individual coolant loops, the mass flow rate measurements for each loop with a Reactor Coolant Pump (RCP) (also called Main Coolant Pumps (MCPs) for some PWR designs) operating along with a mass balance constructed from the water sources of addition (injection) and removal (letdown) from the RCS. If there is a loss of coolant from the RCS, there would be a decrease in the system pressure and in addition, the hot leg temperatures would be essentially the saturation temperature corresponding to the measured RCS pressure. (This relationship is evaluated within the RCS Engineering Module using a set of equations entitled STEAM-WATER PROPS which is a fast execution routine that agrees well with Keenan et al, 1978). This is one of the ways that the RCS Module analyzes other measurements to determine whether these also indicate that a steam void could be forming in the RCS. Through these analyses that are submitted to the Evaluation Module, the RT-EVALS determines the depth of confirmation that is provided by the reactor and containment system measurements.

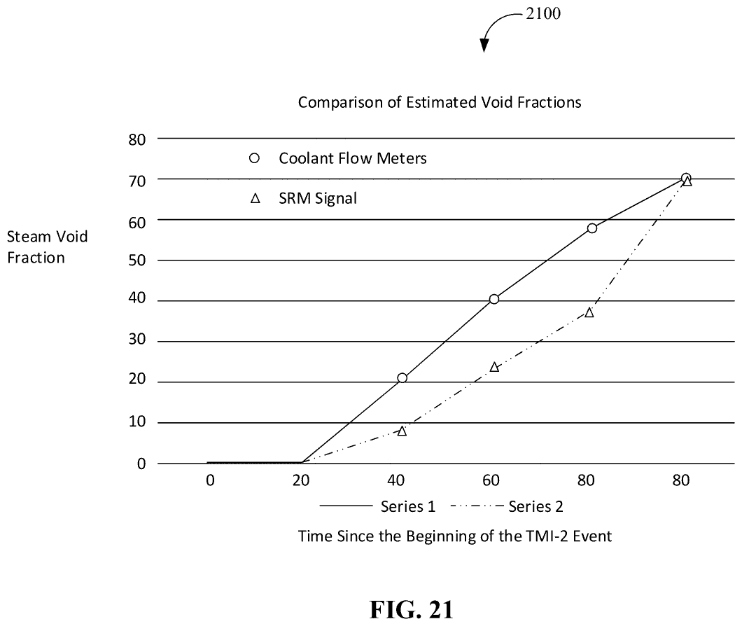

While the RCS pressure and coolant temperatures can indicate whether a steam void could form, these cannot be used to calculate the magnitude of the steam void. However, if the RCPs/MCPs are active in one, or more coolant loops, the individual mass flow rate measurements in each coolant loop with an operating RCS/MCP provide a means for estimating the average steam void that is undergoing forced circulation through the coolant loop as demonstrated by Henry (2011). Here again, the TMI-2 plant data demonstrates how mass flow rate measurements respond to the formation of two-phase, steam-water mixtures in the coolant loops. These evaluations can be used to either assess the steam void formations in the coolant loops with running (energized) RCPs or act as a confirmatory calculation for another such calculation in another module, such as the SRM evaluation in the Core Engineering Module. FIG. 21 illustrates how an estimate of the steam-water void fraction circulated through the TMI-2 loops compares with the observation from the SRM. It is noted that these are not in perfect agreement, but they don't need to be since both indicate a large steam void was developing in the core and is confirmed by the RCS loop mass flow rate measurements. Neither of these instruments was intended to be a void meter and they aren't even in the same location; however, each provides a first-order estimate of the average void fraction and these both indicate that a troublesome situation was evolving. This is confirmation of the fact that water is being lost from the RCS and is a developing challenge to reactor core.

Another assessment provided by the RCS Module is to use the rate of increase in the steam void formed in the coolant loops and the RPV to estimate the possible break size that could be responsible for the coolant loss. Such a calculation would be helpful in terms of detecting what may have been the initial cause of the event and therefore what may be the way in which the event progression could be terminated. From a mass balance, the estimated mass flow rate (WLOCA) through a LOCA can be assessed by:

WLOCA=VRCS(ρf−ρg)[(α2−α1)/(t2−t1)]+Ww,inj+Ww,accum+WwPZR−Ww,LETD−(QD−QSG)/hfg

The variables in this equation are:
hfg—latent heat of vaporization at the RCS pressure (PRCS)
QD—core decay heat (power)
QSG—combined heat removal in the SGs of a given design
VRCS—total internal fluid volume of the RCS (determined from the Plant Design Info file
Ww,accum—combined water flow rate from the accumulators/flood tanks
Ww,inj—combined water injection rate from HPIS, LPIS and make-up pumps
Ww,LETD—letdown flow from the RCS
Ww,PZR— water flow from, or into (-) the pressurizer
α—void fraction measured by the mass flow rate measurement at time (t)
pf—density of saturated water at PRCS and
ρg—density of saturated steam at PRCS

Once the discharge mass flow rate is estimated, the break area (ALOCA) is evaluated assuming that the mass flow rate is limited by the two-phase critical discharge for a steam-water mixture with an average void fraction given by αAVG=(α2+α1)/2. For low and moderate void fractions, the Henry-Fauske critical flow model (Henry and Fauske, 1971) can be approximated for using the following equation:

ALOCA=WLOCA/SQRT{Cd[2(1−αAVG)ρfPRCS(1−η)]}

In the above equation, the term i is the critical pressure ratio that is defined as the ratio of the pressure in the minimum flow area or throat (Pt) of the break or open valve divided by PRCS. As indicated by the experimental data referenced in the Henry and Fauske paper, the value of η for low void fraction, moderate void fraction mixtures have a value of about 0.8, with the discharge coefficient through a valve or an orifice like break also being about 0.8.

Recalling the confusion over the progression of the TMI-2 accident, such calculations would have shown early in the accident (within the first 30 minutes) that a breach in the RCS/PZR pressure boundary, that was approximately of the size of a stuck open PORV, was responsible for the RCS coolant loss. Given the event, there was only one valve that would have been opened by the initiating event (the pressurizer PORV) and this could have been eliminated by closing the block valve in series with the PORV. If the block valve would have been closed at 30 minutes into the accident, the event would have been terminated and the reactor core would not have been damaged.

6.3 Steam Generator (SG) Module

Each steam generator has thousands of tubes through which the high-temperature RCS coolant from the core is circulated and energy is transferred to the secondary water outside the tubes. For at-power conditions, this energy transfer results in a large steam generation rate that is the steam being ducted to the turbine—generator set where electricity is produced. Since these SGs are the principal means of extracting heat from the RCS and the thousands of SG tubes are part of the RCS pressure boundary, this engineering module is of key importance to the evaluation of the plant response.

One possible event/accident sequence to be considered by the Evaluation Module is a High Energy Line Break (HELB) since this could potentially occur either inside or outside of the containment. Should a break occur outside of the containment building as occurred in the feedwater piping rupture at the Surry nuclear plant (1989), this could present an immediate hazard to plant personnel. If such an event occurred, an important signal is the containment pressure since there would be pressurization of the building if a break were to occur inside of the leak-tight containment building, but no pressure increase would occur if the break was external to the containment. As a result, the Evaluation Module checks the Containment Engineering Module to determine whether there is any containment building pressurization and also the SG Engineering Module to see if there is any depressurization detected in only one SG. If so, the RT-EVALS would begin with an indication of a HELB.

Industry experience has also shown that the steam generator tubes can be subjected to long term erosion and corrosion such that individual tube walls have experienced thinning and single tubes have ruptured (Steam Generator Tube Rupture—SGTR) when a plant has been in operation or is in the process of being brought to operating conditions as was the case for the Doel-2 plant on Jun. 25, 1979 (Stubbe et al, 1984 and NRC, 1979). Because the steam generator tubes have a diameter of the order of 1 cm, the SG depressurization rate would be very slow, so there is an extended time to address the event/accident condition.

Consequently, a SGTR is a break location where the RCS pressure boundary would fail with the RCS coolant being discharged through the breach into the steam generator secondary side. As a result, the discharge would cause the secondary side water level, pressure, and radiation level to increase in that SG, with the other SGs remaining unaffected. The increasing water, pressure and radiation levels would trip the reactor, and a transition to long term cooling of the reactor core would begin. With the possibility of a Loss of Coolant Accident (LOCA) combined with the role that the SGs could have in establishing the RCS depressurization and long term cooling, the SG Engineering Module is naturally an essential module to assess the transient performance of all of the SGs in the design, including the unit with the SGTR and transmit the results of these evaluations to the Evaluation Module.

Depending on the plant design, there could be two, three or four SGs, and if the Russian VVER PWR designs are included, there could be six SGs monitored by the SG Engineering Module. The important information to be supplied to the SG Module are the individual feed water flow rates, water levels, pressures, radioactivity levels of the RCS coolant and the status of the Main Steam Isolation Valves (MSIVs). If a reactor trip transient is initiated, the auxiliary feedwater flow rates to the individual generators must also be monitored. These measurements encapsulate the operation of each of the SGs.

6.4 Pressurizer (PZR) Module

In the range of interest, water expands (becomes less dense) with increasing temperature and is nearly incompressible. Consequently, any volume that is completely water-filled would be subjected to a rapid pressurization if energy were added to the volume. To cushion such pressure transients, PWR designs have a separate, vertically oriented tank (the pressurizer) connected directly to one of the hot leg pipes of the water-filled (subcooled water) RCS. To effectively cushion both pressurizations and depressurizations, this tank is approximately half-filled with water and half-filled with steam. With steam being far more compressible than water, the steam volume cushions the RCS and promotes well-controlled, steady-state operation. Further protection against the possibility of high RCS pressures during rapid transients, such as a reactor trip, is provided by a cold water spray into the top of the PZR (see FIG. 16) as well as the one, or two PORV(s) (depending on the design) and Safety Valves (SVs) located at the top of the pressurizer vessel. These can relieve (discharge) steam, or steam-water mixtures into the RCDT (located in the containment) through the tailpipe connecting the pressurizer to this collection tank as discussed above for the TMI-2 design. (Other PWR designs have a similar collection tank, also located in the containment, that is designated as the Pressurizer Relief Tank (PRT) mentioned earlier.) As already discussed, one or more of the pressurizer valves could leak, and/or stick open and develop into a small LOCA with the water being discharged into PRT/RCDT and subsequently into the containment.

Consequently, this sizable storage of cold water combined with the potential for valve leakage as well as the instrumentation associated with the tailpipe and the PRT/RCDT, the Pressurizer (PZR) Engineering module provides another essential component to be included in the RT-EVALS. The measurements of interest for this component are the water level in the pressurizer tank, the valve stem positions for the relied valves where available, the tailpipe temperatures as well as the pressure and temperatures for the PRT/RCDT containment collection tank. (With the direct connection between the RCS and the pressurizer, these can be considered to be at the same pressure with the only difference being the static head of water in the PZR during the transient response.) With their individual responses being well characterized, the tailpipe and collection tank responses are considered in submodules that are called by the PZR Engineering Module.

6.4.1 Pressurizer (PZR) Responses

By design, the PZR responses for anticipated operational transients involve either short term expansions or compressions of the steam volume with the pressurizer water level eventually returning to some relatively constant, measurable water level. Should the PZR lose the entire water inventory within a minute or less, the first cause to consider is a Loss of Coolant Accident (LOCA) in the RCS may be occurring as was observed in the Loss of Fluid Tests (LOFT), see for example Guntay (1990). Conversely, as observed in the TMI-2 accident, if the pressurizer approaches a level that almost fills the pressurizer vessel, it becomes a clear indication that one, or more of the pressurizer valves has/have opened and has/have not reclosed. This was the initiator for the small LOCA in the TMI-2 accident. (This behavior was also observed in LOFT Test L3-0 (Modro, et al, 1987).) If the pressurizer water level remains within the central zone of the measured height, then the event is likely not LOCA related, for example the Mannshan Station Blackout observed the PZR water level to decrease from 60% to 20% of the measured height in one hour (see Che-Hao, 2015).

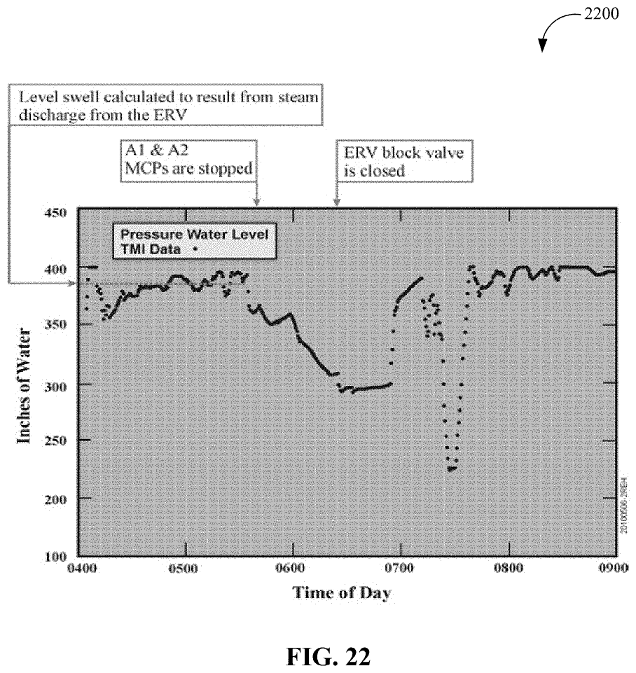

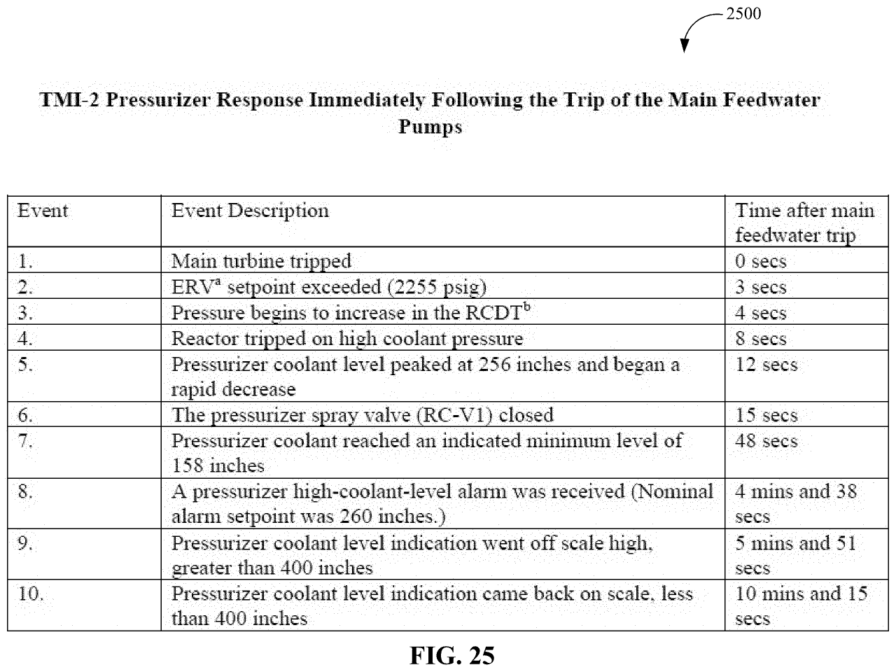

As an example, consider the pressurizer water level response (see FIGS. 22 and 25) following the reactor trip of the TMI-2 reactor that was initiated by the shutdown of two main feedwater pumps. (This information is taken from the sequence of events given in the Nuclear Safety Analysis Center (NSAC) Report NSAC-80-1 (NSAC, 1980)).

Especially note the large fluctuations in the pressurizer water level in the early stages of the transient. These and other behaviors must be part of the system evaluation that investigates the crucial measurements to determine the nature of the developing transient. The character of the transient is suggested by analyzing the ensemble of the measurements with the assessment providing the answers to the questions: (1) what behavior characterizes the ongoing behavior, (2) what are the confirmatory observations, (3) what actions should be considered, (4) what actions are recommended and (5) how much time is available to accomplish these actions? As defined below, the PZR behavior is an essential component of this ensemble.

FIG. 25 outlines the TMI-2 Pressurizer Response Immediately Following the Trip of the Main Feed Water Pumps.

6.4.2 PZR Valve Discharge Rates

For most reactor trip transients, such as a loss of load, loss of off-site power, etc. the transient occurs sufficiently rapidly that the RCS pressurization causes the opening of the PORV and perhaps the safety valves. The TMI-2 Electromatic Relief Valve (ERV), which was the PORV for the TMI-2 plant, had an opening set point of 2255 psig (2269.7 psia/15.65 MPa) compared to the nominal operating pressure of 2200 psig/15.17 MPa (NSAC, 1980).

Eventually, the PORV and perhaps one or more safety valves would likely open. With the magnitude of the pressure difference and the RCDT (which is about the containment pressure), the flow through these valves would be limited by the maximum compressible flow of the fluid being discharged. For the discharge of single-phase steam flow through one, or more of these valves, the mass flow rate discharged (Wst) can be determined by:

Wst=CdAvSQRT[{2γ/(γ−1)P0 ρ0(ηpow(2/γ))[1−pow((γ−1)/γ)]}]

where η={2/(γ+1)}pow[γ/(γ−1)]=Pt/P0

(In these equations, the use of “pow” indicates that the following bracketed term is the power for the term immediately before the “pow” and SQRT is the square root of the term in brackets.)

In this expression, Av is minimum flow area through the valve(s), Cd is the empirical compressible flow discharge coefficient for the valve, P0 is the PZR pressure, ρ0 is the steam density in the pressurizer, γ is the isentropic coefficient for steam at P0 and η is the ratio of the throat pressure (Pt) divided by P0. At a pressure of 15.56 MPa saturated steam has a density of 104.2 kg/m3 and γ=1.25. Initially assuming a value of Cd=1, the values given above result in a steam mass flow rate of 26,576 kg/m2/s or 142,495 lbm/hr. The characterization for the TMI-2 ERV in the NSAC-80-1 report gives a mass flow rate of “approximately 100,000 lbm/hr of saturated steam”, which corresponds to a mass flow rate of 12.6 kg/s and a value of Cd=0.7. This value is close to that which would be expected for such systems (Henry and Fauske, 1971). With this mass flow rate, the volumetric flow rate leaving the PZR would be 0.121 m3/s.

Once the valve opens to vent steam, the water level would increase as water flows into the pressurizer from the hot leg to replace the steam volume vented. When the RCS approaches being full of water, which is the applicable configuration with the water level continuing to increase. Two facets of this process could influence the transient PZR water level measurement. The first is that the reduction in pressure may cause some flashing of water to steam within the bulk of the PZR water inventory. This has a minor influence on the static head of the water inventory, but the formation of steam bubbles within the liquid water would cause an expansion of the water volume where this occurs with the consequence of some level swell of the upper water surface.

As the water level approaches the top of the pressurizer vessel, this level swell would cause a two-phase, steam-water mixture to enter the open valve instead of single-phase saturated steam. A discharge of a two-phase, steam-water mixture from the pressurizer has an important influence in terms of (i) the mass flow rate increases, and (ii) the volumetric flow rate decreases. Experimental data (Ginsberg, et al, 1977, Grolmes et al, 1985, Fletcher and Denham, 1993 and Henry et al, 2015) have shown that the two-phase water level increases (typically described as level swell) with the rate of steam formation beneath the collapsed water level. Knowledge of the steam discharge mass flow rate and the dimensions of the PZR vessel provide the necessary information to calculate the level swell. This is a simple calculation that can be evaluated in real-time by RT-EVALS during the evolving event.

For the TMI-2 event/accident, this would generate an average void fraction of about 7% over the 400 inches of measured height. Consequently, multiplying the measurement height and 0.07 gives a level swell of about 28 inches. (It is important to note that the level swell does not change the collapsed water level that is measured by the static pressure devices such as differential pressure transducers.) FIG. 22 compares the water level measurement with the above calculations for the first 100 minutes when at least two of the Main Coolant Pumps (MCPs) when running. As indicated, the level swell evaluation compares well with the measurement once the pressure became relatively constant at 1000 seconds. This sustained water level indication in the PZR is, by itself, an important result indicating a continuous discharge of a steam-water mixture from the top of the PZR. This behavior results naturally from the affected pressurizer and this information is supplied to the Evaluation Module by the PZR Engineering Module as an important first-order result to be confirmed by other measurements.

6.4.3 PZR Tailpipe Temperature Measurements

With the continued steam and/or steam-water discharges indicated by FIG. 22, there is a need to check if this observation can be confirmed by independent measurements. (Independence in this regard is a measurement that is not merely another measurement of the same quantity, such as a pressure measurement being confirmed by another pressure transducer monitoring the same pressure.) In this regard, FIG. 16 shows that an important part of the PZR module is the measurements of the tailpipe surface temperatures, which is an independent measurement to confirm, or not, that there is a sustained discharge from one or more of the valves at the top of the PZR.

If there is a critical discharge (flow) of steam or a steam-water mixture through a stuck open valve, the discharge into the much larger tailpipe can be assessed as a freely expanding jet that eventually occupies the entire cross-sectional area of the tailpipe. The discharge mass flow rate of steam (Wst) or a two-phase mixture is the product of the fluid density at the valve throat (pt), the effective cross-sectional area of the valve (Cd At) and the throat velocity (Ut) which is the sonic velocity of the steam or a two-phase mixture:

Wd=ρt(CdAt)Ut

The free expansion of the critical flow jet downstream of the throat as the lower pressure in the expansion zone (Pe) accelerates the critical flow jet to the velocity Ue as defined by the momentum equation

Pt−Pe=Cd(Wd/At)(Ue−Ut)

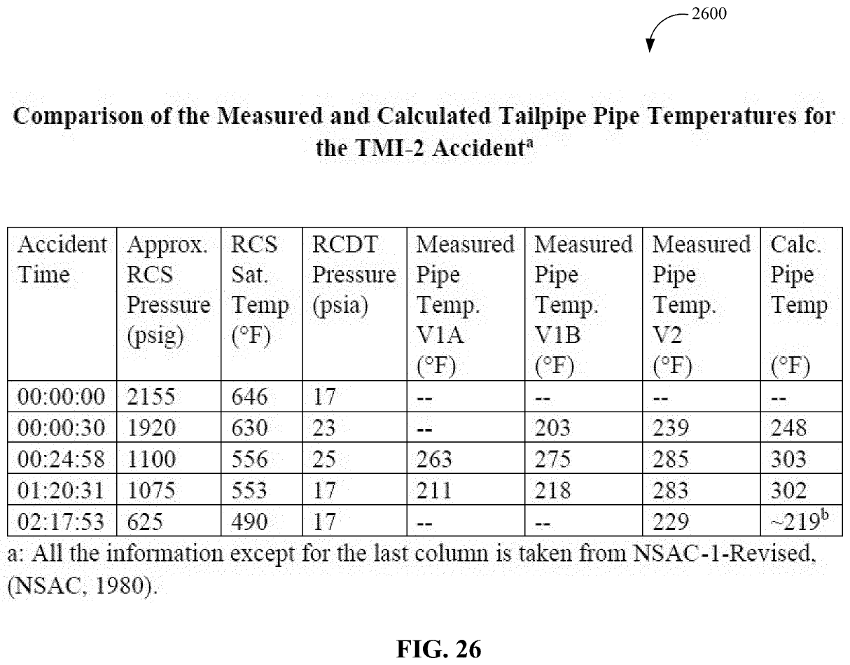

Assuming an isentropic expansion for the steam or two-phase mixture, then the above equations can be solved by iteration to determine the consistent values of Pe and Ue that are needed for the discharge mass flow rate and the piping cross-sectional area (Ae). The pressure Pe determines the temperature of the expanding jet.
Of the valves that vent from the top of the PZR, the PORV has the lowest setpoint, so it would be the first, and possibly the only valve to open. Therefore, it is the most likely to become stuck in the open position. Considering this to be the case, the temperature of the expanding steam, or steam-water discharge can be quantified as being in equilibrium at the calculated pressure for the fully expanded jet. The results of the TMI-2 measured temperatures and those calculated for the stuck open PORV are listed in FIG. 26 below. At 30 seconds, the water level in the PZR was not sufficiently high to cause the venting of a steam-water mixture, so the calculation is for steam venting at the RCS pressure. As noted, the calculated value is close to the maximum measured value. (Note that the calculation is of the gas temperature in the expanding free jet but the measurement is on the outer surface of the tailpipe. Therefore, the calculation does not include any heat losses through the pipe wall. Nonetheless, it is indicating a reasonable estimate for the continuous, single-phase, steam flow condition.)

Both of the values recorded at 24 minutes and 58 seconds, as well as that one hour, 20 minutes and 31 seconds, are when the PZR water level is near the top of the vessel, so a steam-water mixture was being discharged, which results in a much higher pressure for a fully expanded jet and the temperature is consequently more than 50 F higher. As listed in the table, the measured maximum values are also increased by a similar increment. Hence, the measured tailpipe temperature measurements also indicate that there is a two-phase mixture flow through the pipe and into the RCDT.

Lastly, at 2 hours, 17 minutes and 53 seconds, the measured PZR water level has decreased such that only steam could be vented from the PZR and both the measured and calculated tailpipe temperatures have also decreased nearly to the atmospheric saturation temperature. From these comparisons with different PZR water level measurements, the tailpipe temperature measurements provide confirmation that a continuous discharge was ongoing for over two hours following the initiating transient. Moreover, the measured values indicated when the discharge was steam and when it was a two-phase mixture. Therefore, this measurement provided an ongoing powerful confirmation of the event behavior, and in the RT-EVALS methodology, this would be transmitted to the Evaluation Module for its understanding of what measurements have independently confirmed behaviors. If only the control room operators had been given the temperature measurement levels to expect during such a discharge, they would have known immediately what was happening in the plant.

FIG. 26 refers to the Comparison of the Measured and Calculated Tailpipe Pipe Temperatures for the TMI-2 Accident.

6.4.4 RCDT/PRT Pressure Measurements

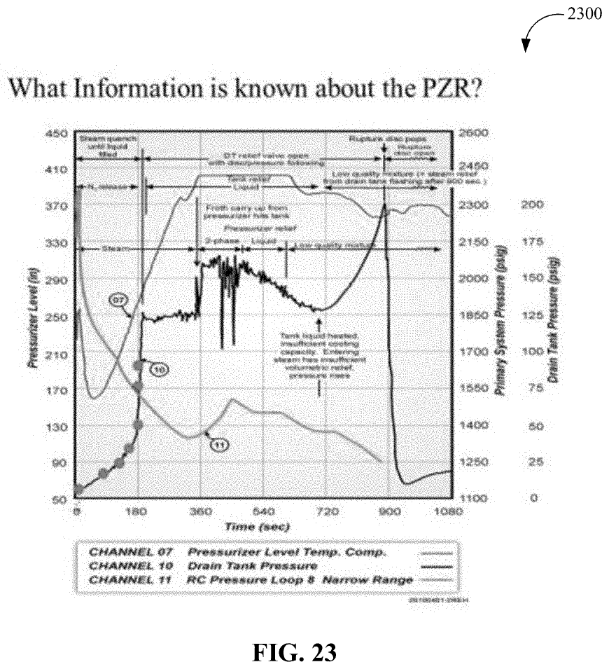

In addition to the use of the tailpipe information, FIG. 16 also shows that the pressure and temperature measurements of the RCDT/PRT are another part of the list of measurements to confirm the state of the PZR valves (either all eventually are closed or at least one is stuck open). FIG. 23 illustrates the pressurization that was measured in the RCDT in the early phase of the accident. Specifically, the recorded trace of “Drain Tank Pressure” shows a significant pressure increase within the first three minutes of the plant transient. (Note from the “Primary System Pressure” shown in FIG. 23, the PORV should have reset after about 10 seconds of lifting. Thus, the extended flow through the tailpipe should not occur if the system performed as designed.) The strip chart with this information was in a cabinet behind the main control cabinets and was not observed by the control room operators. However, if this information was available on the plant computer, this pressurization could be accessed and compared to the data from the other instruments and within the first three minutes there would have been a realization of a sustained high PZR level that would have concluded a stuck open valve was discharging the primary coolant water to the containment. In the RT-EVALS methodology this RCDT pressurization history would increase the depth of independent confirmation to that already obtained from the tailpipe temperatures.

FIG. 23 also shows the results (gray dots) of the calculated pressurization assuming the PZR PORV is stuck open and with a steam-water mixture discharging into the drain tank that is half full of water. This simple calculation, which can be performed much faster than real-time, is in good agreement with the measured behavior. Consequently, the discharge flow rate could also be estimated from the measured pressurization rate if it was needed. In summary, what this RT-EVALS methodology accomplishes is the immediate usage of all the relevant information to detect an evolving challenge and determine the depth of confirmation of the conclusion. This can all be accomplished through straightforward calculations that can be executed essentially as rapidly as the data is available from the plant computer.

6.5 Containment Module

All PWR designs in the western hemisphere have leak-tight, high-pressure containment buildings that encapsulate the RCS and the SGs. By law, these containment buildings are periodically pressure tested to their design basis pressure. With its role of containing any RCS coolant that could be discharged as a result of an event/accident condition, the Containment Engineering Module is also a fundamental component of the RT-EVALS evaluations.

With its role as a containment of the RCS water and steam that could be lost from the RCS, the measurements of interest for this module are any features that could cause elevated temperatures, pressures and/or radiation levels in the building and any increases in the sump water level(s) that could be detected. All containments are designed with cooling systems to remove decay heat from the building by water sprays that condense steam discharged into the building and some containments also have safety-related air coolers that are designed to remove decay heat through steam condensation. There may also be other air coolers that are designed for the smaller heat loads that are related to steady-state plant operation. All containments have decay heat removal systems that remove high temperature water from the RCS and/or containment, pass the water through heat exchangers to cool the water and then return it to the RCS and/or containment. Consequently, this RT-EVALS uses the containment pressure and temperature measurements as well as the information on the water and steam-air flow rates through the heat exchangers and coolers and the temperature differences across these heat exchangers and coolers (large and small) were available depending on the plant design. Returning to the TMI-2 accident data for example calculations that would be performed by the Containment Engineering Module, the first indication of a developing condition in the containment (aka as the reactor building in the TMI-2 documentation) is building pressurization that began about 15 minutes into the event. Steam discharge into the building started with the RCDT rupture disk failure and this caused the pressure to increase by 2 psi (0.14 bars) over an interval of about 5 minutes and then this overpressure remained nearly constant over the next 2 hours.

Given the measured building pressurization, the Containment Engineering Module uses this as one means to estimate the steam flow rate into the containment. Specifically, the estimate assumes no steam condensation during the initial pressurization as represented by the differential form of the perfect gas equation:

Wst˜[(VgconMw/(RTg)]{dP/dt−(P/Tg)dTg/dt}

In this equation, R is the Universal Gas Constant (8314 J/kg-mols/K), Tg and P are the measured gas pressure (Pa) at the beginning of the pressurization, Vgcon is the gas volume (m3) in the containment, Mw is the molecular weight of steam (18) and the rates of change for the pressure and temperature are dP/dt and dTg/dt respectively. (It is noted that the first term (dP/dt) is about four times larger than the second term so if the temperature measurements are slower in responding than the pressure measurements, the estimate will be larger and therefore more conservative.) Since the condensation rate would likely increase directly with the steam partial pressure, it is preferable that the estimate for the pressurization rate be taken as a current value minus the initial pressure once the containment pressurization begins.

Examining the data from the TMI-2 accident, the initial pressurization rate at 15 minutes into the event is approximately (0.0069 psi/s or 47.6 Pa/s) with the measured air temperature experiencing about an 11° C. increase during the five-minute pressure increase (NSAC 1980). With a containment gas volume of 56,600 m3 and a gas temperature of ˜300 K, the estimated steam discharge rate into the containment is about 14.5 kg/s. With a heat of vaporization for water of 2.366×10E6 J/kg, this steam discharge corresponds to an energy addition rate of 34 MW. This is comparable to the decay heat generated in the core and is a clear indication that there is a developing situation with considerable steam discharge into the containment that needs to be continually evaluated by the RT-EVALS. This information would be passed to the Evaluation Module to compare with the results of other engineering calculations provided by the other engineering modules.

Once the containment pressure increased by 2.5 psi (0.17 bars) (NSAC, 1980) and the air temperature increased to about 135 F (57 C), this condition remained nearly constant for two hours. This was because the five containment air coolers were all operating at their highest design flow rate of 42,590 scfm (20.1 m3/s) at atmospheric pressure (NSAC, 1980). With the design volumetric flow rate and an air density of about 1.19 kg/m3 at moderate pressures, this would be a mass flow rate of 23.9 kg/s for each cooler.

The energy removal rate via steam condensation in the containment air coolers (aka fan coolers) can be estimated by assuming that the air entered each air/fan cooler with a humidity of 100% and that the steam was completely condensed as it passed through the cooler. This estimate of the energy removal rate for a single air/fan cooler can be quantified by:

dE/dt=QFANFLOW1*ρst*hfg

where ρst and hfg are the saturated steam density and latent heat of vaporization at the steam partial pressure respectively. Assuming that the extent of pressure increase is steam partial pressure (0.17 bars), the steam density would be approximately 0.114 kg/m3 and the latent heat of vaporization would be the value given above (Keenan et al, 1978). The estimate for total energy removal rate for the containment is the product of the above equation and the number of fan coolers operating (NFANS).

dEtot/dt=NFANS*dE/dt

Using the above expressions, the energy removal rate for each air cooler is estimated at 5.42 MW and the total removed by five fan coolers is calculated to be 27.1 MW, which is also comparable to the decay heat generated in the core (˜30 MW). As noted with the other estimate of the steam discharge to the containment, a heat load approaching, or exceeding the decay heat is a clear indication of a LOCA in either the RCS or PZR or possibly a HELB within the containment. If the steam discharge continues for tens of minutes, it is clearly a LOCA.

With these estimates of the pressurization rate and the energy removal rate from the air coolers, the Containment Engineering Module would have detected and concluded that the ongoing event has the characteristic of a LOCA. Both of these would be reported to the Evaluation Module where these could serve as an independent confirmatory observation for the analyses previously performed by the other engineering modules.

In this regard, it is important to note that the TMI-2 containment pressurization did not start until the Reactor Coolant Drain Tank (RCDT) rupture disk burst at about 15 minutes into the event. Therefore, the containment contribution to the Evaluation Module may occur somewhat later than the analyses provided by the Core, RCS and PZR Engineering modules. Nevertheless, the internal engineering evaluations of the module either confirm or add to the depth of confirmation of diagnosis from other engineering modules.

Both containment estimates are comparable to the decay heat and this is more than sufficient to detect whether there is a developing situation that could challenge the containment integrity. Moreover, it is also clear that the starting of either the safety grade air coolers and/or the design basis containment sprays would be sufficient to reduce or limit the containment pressure. It is important to note that these two estimates occur at two different time intervals, the pressurization rate is only meaningful for a few hundred seconds and then containment pressure became nearly constant. Nevertheless, the Containment Engineering Module stores both histories so the Evaluation Module can look backward in the event history to potentially understand the detailed history of the event development if necessary.

6.6 The Evaluation Module

This module gathers the results from the engineering calculations and evaluations provided by each of the five Engineering Modules. With these, the Evaluation Module then searches for a possible fit for the event progression as well as confirmation from independent data sources that a type of accident condition is developing.

There are four types of plant initial conditions that need to be considered: (i) at-power (ii) scrammed from an at-power-state, (iii) shutdown with Reactor Pressure Vessel (RPV) head in place and bolted down consistent with the design basis and (iv) a shutdown state for refueling/maintenance with the RPV head either removed or not bolted down. Fundamentally, there are only two event/accident types that relate to possible challenges to the reactor core, (1) a Loss of Coolant Accident (LOCA) and (2) a loss of adequate heat removal. The RT-EVALS methodology will use the plant measurements, in real-time, as described above to decipher whether a LOCA is in the RCS, the PZR, one of the SGs or an Interfacing System LOCA (ISLOCA) and search for possible corrective actions. Moreover, if the accident type is a loss of adequate heat removal, RT-EVALS will rapidly search in real-time for the alternate ways to achieve the needed heat removal capability and continually provide forward-looking projections regarding the time available before core damage could be anticipated, including flexible strategies (FLEX) where needed capabilities could be transported to the plant site. There are other event types that influence the balance of plant, such as a High Energy Line Break (HELB) and these are also considered by the Evaluation Module.

Also, there are accident event types that could involve an Anticipated Transient Without Scram (ATWS) that are addressed by the control room EOPs. These are part of the operator training on plant-specific simulators and are not specifically examined in the RT-EVALS. For the remaining accident types, the reactor would be scrammed and a possible LOCA would have the potential to be the most rapidly developing. Therefore, the Evaluation Module begins by examining the SG, RCS, Core PZR and Containment Engineering modules for any signs of a HELB, one of the possible LOCAs mentioned above or a loss of adequate heat removal. Consequently, the first quire is whether there is evidence of a HELB since this could possibly be an immediate hazard to plant personnel.

Information Transmitted by the Steam Generator Module
1. Is the pressure in one of the SGs rapidly decreasing and is much less than those of the other SGs? If so, there could be a HELB.
2. Do one or more radiation monitors in a single SG indicate a rapid increase? If so, a Steam Generator Tube Rupture (SGTR) may have occurred in that SG, which is also a LOCA for the RCS.
3. Have the secondary side pressure and water level increased in the SG with the increased radiation monitor? This response would also indicate that a SGTR had occurred, i.e. a LOCA.
4. Is there water inventory and injection into one, or more of the SGs to provide the necessary decay heat removal from the RCS?

Information Transmitted by the Core Module
1. If the reactor control rods are fully inserted into the core and the SRMs show an increasing signal compared to the normal monotonic decreasing decay characteristic following a reactor scram, a steam void is likely forming in the Core and the RCS which indicates a net loss of water from the RCS (either a LOCA or a loss of adequate heat removal capability).
2. Does the Reactor Vessel Level Indication System (RVLIS) system indicate a decreasing water level in the reactor core? If so, a steam void is likely forming in the core region.
3. Do the core exit thermocouples indicate temperatures significantly greater (a few hundred degrees) than the water saturation temperature corresponding to the RCS pressure? If yes, the core is likely partially uncovered. This could result from either a LOCA or a loss of adequate heat removal capability.

Information Transmitted by the Pressurizer Module
1. Is the PZR water level measurement approaching, or at the bottom of the measured height? If yes, it is possible that there is a LOCA in the RCS. If this is the case, the LOCA size can be estimated from the volumetric discharge rate from the PZR (assuming the plant computer is reporting the data sufficiently rapidly) and the subcooled critical flow rate (Henry and Fauske, 1971).
2. Is the PZR water level measurement near the top of the measurement height? If yes, this indicates a possible LOCA in the top of the PZR (likely a stuck open valve). Here also, the LOCA size can be estimated from the
3. Do the tailpipe temperatures consistently read temperatures near, or above 100 C/212 F? If yes, these are indicating, or confirming a stuck open valve (LOCA) at the top of the PZR with continuous discharge of steam or a steam-water mixture.
4. Has the PRT/RCDT recorded a substantial pressurization or has the rupture disk failed? If yes, this indicates or confirms a stuck open valve at the top of the PZR.
5. If the reactor is scrammed and the PZR water level remains in the normal operating range then the only type of LOCA that could exist in the RCS or the PZR would be of the small-small category if at all (for example see the Oconee plant behavior for a extraction line break discussed by Kuhr et al, 1984).

Information Transmitted by the RCS Module
1. Is the RCS pressure approaching the saturation value corresponding to (associated with) the hot leg temperatures? If yes, there is a possibility that a LOCA could be occurring in the RCS.
2. Is the pressurizer (a) emptying, (b) filling or (c) remaining about the same as normal operation? If “a” is true there could be a LOCA in the RCS, if “b” is true there could be LOCA in top of the pressurizer and if “c” is true there is no indication of a LOCA from the pressurizer.
3. For those sequences where the RCPs/MCPs remain energized and circulate the RCS water through the core, do the mass flow rate meters in the active loops indicate a decreasing mass flow rate in these loops? If yes, these are likely indicating a growing steam void in the RCS coolant and therefore, a possible indication of a LOCA or the RCS may be progressing toward an inadequate core cooling challenge.
4. If the mass flow rate measurement(s) in the circulating coolant loop(s) with an energized RCP/MCP show a decreasing mass flow rate, this would indicate the formation of a steam void in the RCS. Using the rate of increase of the RCS steam void, the size of the possible break can be estimated. Does the effective LOCA size evaluation indicate such an accident condition? If yes, a LOCA needs to be considered.
5. If this engineering module detects and confirms that a LOCA could exist, and is the estimated LOCA size consistent with any RCS component that could have failed during the initiating transient? This information is conveyed to the Evaluation Module.

Information Transmitted by the Containment Module
1. Have the containment pressure and temperature increased significantly since the reactor scram? If yes, there could be a HELB or a LOCA that is discharging steam or a steam-water mixture into the containment.
2. Are the containment air coolers operating? If yes, does the evaluation of the steam removal rate for at least 10 minutes show values that are greater than 20% of the decay heat generated in the reactor core? If yes, it is likely that there is a LOCA in the RCS.
3. If the air coolers are not operating, is the containment pressurization rate greater than 50% of that corresponding to the adiabatic increase rate? If yes, there is either a LOCA of a loss of adequate core cooling occurring.
4. If the RCS and PZR Modules would detect and confirm that a LOCA is occurring BUT there is no indication of steam discharge to the containment then it would be likely that an “Interfacing Systems LOCA (ISLOCA)” had been initiated. This sequence was identified in WASH-1400 (NRC, 1975) and involves the failure of valves and/or check valves that could cause a break to occur in the auxiliary building; outside of the containment. This has a very low likelihood of occurrence, but if it were to occur, it needs to be dealt with immediately. Time is of the essence! RT-EVALS would detect this as fast as a LOCA condition could be confirmed, which would be 10 minutes or sooner, depending on how often the plant computer reports the plant measurements and the size of the LOCA.

Projection of Near-Term Behavior

As noted above, the principal objective of the RT-EVALS is to analyze the plant information from all of the major components to develop a common understanding of the developing transient on a real-time basis along with the depth of confirmation provided by independent measurements. In addition, the methodology can use the much faster than real-time internal models to provide near term projections for addressing “what if” questions related to actions that could be taken and also to provide projections related to “how long before . . . ” assessments. This could have an important function as part of the implementation of the FLEX capabilities where additional power, pumping and heat removal systems can be supplied from a remote site. For example, if those in the Technical Support Center (TSC) want to know what would be the influence of hooking up a fire water pump to the secondary side of a SG in 15 minutes and injecting a flow rate of 10 kg/s, the near term projections will take the current status, assume that the event progression will remain as it is currently progressing for 15 minutes and begin to inject this flow rate into one of the SGs and graphically illustrate on a cell phone or a computer tablet how the event progression will be changed. Most importantly, this will be calculated and displayed much faster than real-time so those in the TSC can determine if the action will accomplish the desired behavior. As noted, where appropriate these assessments use the same physical models, such as the size of a LOCA, the steam-water discharge mass flow, the temperature increase caused by decay heat for uncovered portions of the reactor core that have been used to evaluate the evolving transient, so these will produce conservative projections for the near term behavior. Moreover, if needed, the models embedded in the Engineering Modules can make projections into the core damage states of early and late phase hydrogen generation that could result from extensive overheating of the reactor fuel pins, particularly the Zircaloy cladding in a steam environment.

7. Recommended Actions and Near-Term Projections Block

This segment of the RT-EVALS methodology utilizes the comparative information and depth of confirmation provided by the Evaluation Module to recommend actions to be taken to recover from the accident conditions and/or mitigate the consequences of the developing transient. The objective of the actions is always to eventually terminate the event progression, but some actions may need to be taken in the interim, such as controlled venting of the RCS, the SGs and/or the containment, to maintain the capabilities of the reactor/containment designs. In general, these recommendations focus on making sure there is adequate water injection to the RCS and the SGs for core cooling and for decay heat removal. Furthermore, there are considerations related to depressurizing the RCS and potentially the SGs, but these are generally achieved through the EOPs. Other actions could include using the FLEX capabilities provided to the reactor site, as well as short term containment venting to keep the pressure well below the design basis level.

According to some aspects, a new, real-time methodology is disclosed. The methodology can be used to interpret the transient plant data as it is recorded to diagnose, confirm and communicate to the plant management and designated personnel whether there are developing conditions that could eventually challenge cooling of the reactor core, integrity of the RCS and/or containment boundaries.

According to further aspects, the methodology is based upon Engineering Modules that perform engineering evaluations of the transient plant data, as it is recorded, in innovative ways that, while somewhat different is completely consistent with the ongoing physical processes and what has been observed in well-documented plant transient behavior and accidents.

According to further aspects, the engineering modules have subordinate modules that analyze the response and performance of dedicated systems such as temperature measurements on the pipe connecting the PZR relief valves to the RCDT/PRT, the pressure history measured in the RCDT/PRT, water injection to the RCS, water addition to the containment sprays, localized heat removal for the containment and others.

According to further aspects, the engineering modules make use the readings of standard existing instrumentation, such as the SRM, RCS loop flow rates, containment pressure history in innovative ways that are consistent with the behavior of these instruments in the well documented Three Mile Island Unit 2 accident and other plant transients.

According to further aspects, the engineering modules can accept manual entries of observations in the plant such as “steam is being discharged into the turbine building”, “steam is being discharged into the auxiliary building”, “one of the service water pumps is disabled for maintenance”, or others.

According to further aspects, the information from the engineering modules can be supplied to the evaluation module to compare the results from each engineer module to determine the nature of the developing transient as well as the depth of confirmatory analyses regarding the transient behavior. Examples of challenging transients that could develop are: a High Energy Line Break (HELB) inside of containment, a HELB outside of containment, a Loss of Coolant Accident (LOCA) in the Reactor Coolant System, a LOCA in the pressurizer (PZR), a Loss of Feedwater (LOFW) event, an Interfacing System LOCA (V Sequence), a Steam Generator Tube Rupture (SGTR), the loss of one or more Emergency Core Cooling Systems (ECCS), Loss of Off-Site Power (LOSP), total loss of off-site and on-site AC power designated as a Station BlackOut (SBO), loss of adequate core cooling during mid-loop maintenance operations and others.

According to further aspects, the results of the Evaluation Module can be supplied to the Recommended Actions block to supply to the plant management for their decisions of whether or not to: (i) provide additional information to the main control room, (ii) provide specific help to specific parts of the plant, (iii) request the need for help from a FLEX facility, (iv) inform state and local regulatory agencies and others.

According to further aspects, the results of the Evaluation Module can be used to provide near term projections, with each recording of the plant data, regarding the progression of the event with the objective being to establish an event timeline quantifying intervals of when specific plant capabilities would be required and whether these capabilities were available on-site or would need to transport to the site.

According to further aspects, the RT-EVALS methodology is a real-time tool designed for the management and operating personnel outside of the main control room that analyzes the evolving plant information for a commercial PWR nuclear power plant following an operating transient that can be observed in real-time on cell phones or computer tablets that are authorized for plant management and operating personnel.

8. Early Phase H2 Generation

1. Background

Under accident conditions where continuous water addition to the reactor core could have been disrupted, the water inventory in the Reactor Coolant System (RCS) could maintain core cooling through water vaporization (boiling). However, without sufficient water injection, boiling would deplete the water inventory in the Reactor Pressure Vessel (RPV) and in the reactor core. Steam generated beneath the water level would increase the level somewhat (level swell) and this would act to extend the core cooling interval. Most importantly, when the water level is above the top of the core, boiling (vaporization) of the coolant will maintain the core temperatures close to the saturation temperature (boiling point) corresponding to the RCS pressure. However, without water addition to offset the vaporization, the water level would eventually decrease below the top of the reactor core. Once uncovered, the top of the reactor core would begin to overheat.

2. Uncovering of the Reactor Core

Water vaporization (boiling) due to the core decay heat generation without water addition would cause a decrease in the water level (Lw). When the core is submerged in water, it will not overheat. Should the water level decrease below the Top of Active Fuel (TAF) (Lw<the core height Lc), the water level will begin to decrease at a rate determined by the extent of decay heat generated beneath the water level. This can be estimated with the following one-dimensional continuity expression in terms of the dimensionless core height z=Lw/Lc:

−ρwAwLcdz/dt+Wadd=zQD/hfg

This approximate formulation assumes that the heat flux is uniform over the core height and that there is no significant oxidation of the Zircaloy cladding. Other terms are defined as: Aw is the cross-sectional area for water in the RPV with access to the core (core+bypass+downcomer), hfg is the latent heat of vaporization of water at the RCS pressure, Wadd is the water addition rate to the core and ρw is the water density. QD is the total decay generated in the core at a given time. El Wakil (1971) has shown that the decay heat can be represented over long time intervals following shut down of the fission reaction by:

QD//Qc0=0.095tpow(−0.26)

In this expression, Qc0 is the long-term core power level (2780 MWt for TMI-2) that characterized operation before the shutdown and t is the time since reactor scram in seconds.

To estimate the potential for core overheating, it is conservative to assume that the water entering the core is saturated at the local pressure. Additionally, the following solution assumes that the RCS pressure remains constant as the core water level changes, so the water properties remain constant. Integrating the above expression from 1 to z results in:

−ln(z)=C1Δt
where C1 is a constant value given by:

C1=QD[ρwAwhfgLc]−1

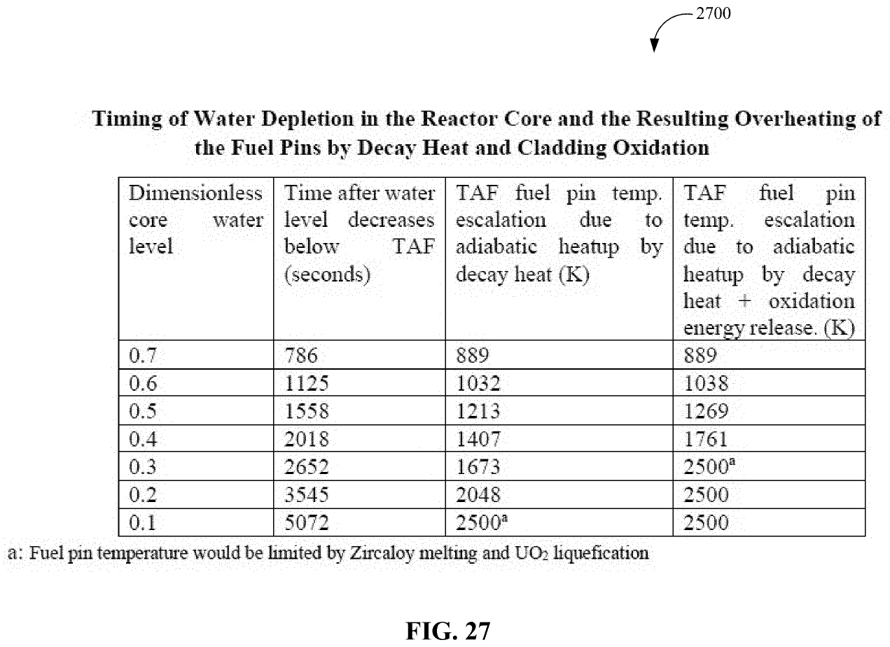

Future projections for accident conditions that could lead to uncovering of the reactor core need to provide realistic representations of the transient fuel pin cladding history. To develop a perspective on the controlling processes for the rapidity of the increase in the cladding temperature, it is helpful to examine the TMI-2 core temperature increase as water vaporization depleted the core water inventory according to the above one-dimensional model. From the core design information, the active core height (Lc) is 3.66 m and the term Aw is about 14.9 m2. Furthermore, at the time that the core water level began to decrease below Top of Active Fuel (TAF) (approximately 100 minutes (6000 seconds) that corresponds to when the last Main Coolant Pump was tripped), the RCS pressure was approximately 7 MPa with a saturation temperature of 286 C (559 K), hfg is about 1.5×10E6 J/kg and the water density is 741 kg/m3 (Keenan et al, 1978). Substituting these values into the above equation and solving for the time interval for the water level to reach the lower levels of the core gives the results shown in FIG. 27.

As shown in FIG. 27, the water level decreased to the mid-core height over about 26 minutes (1558 seconds). As the water level decreases, the fuel pin material and the fuel pin cladding need to develop a significant temperature greater than that of the steam before any axial position can transfer the energy generation rate produced by decay heat. As this temperature difference is developing, the core temperatures are principally increasing adiabatically (dT/dt)AB) as a result of the decay heat generated within a segment. The adiabatic rise rate given by:

dT/dt)AB=QD/[mccc]

where mc is the core mass with cc being the average specific heat of the core materials. The total mass of materials in the TMI-2 core is 129,700 kg (Henry, 2011) and for the estimates of the adiabatic rate of rise, the average specific heat can be taken to be 500 J/kg/K. Adiabatic heating of the TAF region by decay heat alone is shown in the third column of FIG. 27

Since the Zircaloy cladding is in a steam environment, increasing cladding temperatures increases the rate of oxidation, which is described by the following balance:

Zr+2H2O→ZrO2+2H2+ΔHR

Once the cladding wall temperature (Tw,TAF) has been estimated, the oxidation behavior for this highest temperature locale can be also be determined using the Arrhenius equation proposed by Cathcart et al (1977) that was derived from zirconium oxidation experiments taken in the temperature range up to 1580° C. (1853K). This correlation for the Zircaloy mass reacted per square meter (w in units of kg/m2) within a specified time interval (t) in seconds

is given as:

w2=294t exp{−1.654×10E8/R/Tw,TAF}

where “exp” is the natural logarithm raised to the power of the bracketed term that follows and R is the universal constant of 8314 J/k/kg-mol. The fourth column in FIG. 14 shows the estimates considering the adiabatic heating of the core exit region due to both decay heat and the energy release resulting from Zircaloy oxidation.

Once the core was approximately half uncovered, the core exit region would have reached temperatures where the rate of chemical energy release is comparable to the decay heat. As the depletion of the core water inventory continued, the energy release rate due to oxidation became the dominant energy source and by the time that the water level decreased to 40% of the active core height, the core exit temperature reached the melting temperature of the stainless steel, and/or Inconel core components which are usually the in-core instrumentation. This was the onset of rapid oxidation as well as configurational changes in the reactor core, and for a short interval, the oxidation occurred as fast as steam was generated in the lower part of the core; a condition characterized as “steam starvation”. With the exponential character of the oxidation reaction, most of it occurs during the relatively short “steam starvation” interval defined by the fuel pin temperature approaching the stainless steel/Inconel melting temperatures and the melting/liquefication of the Zircaloy cladding and the oxidic reactor fuel that results in the downward flow of molten debris.

Note that the number of the hydrogen kg moles produced equals the kg moles of water vaporized. (ΔHR is the energy (heat) released by the oxidation reaction, which is 6.84×10E6 J/kg of zirconium reacted.) Consequently, the resulting calculated H2 mass-generated is 448 kg. This is in close agreement with the hydrogen generation estimate of 460 kg by Hendrie (1989) and it also agrees well with the observations in the Phebus in-reactor experiments (Bourdon et al, 2002, Di Giuli et al, 2015 and Sangiorgi et al, 2015) for early phase hydrogen generation.

With the bottom half of the core being much cooler, the molten material froze and blocked the coolant flow passages in that region. This ended the steam flow through the core along with the “steam starvation” behavior. Post-accident observations of the TMI-2 lower core region confirmed the frozen debris, blocked flow path configuration. Equally important, this provides a fast, realistic method for estimating when major core damage could occur as well as reliable estimates of the possible extent of hydrogen generation during the early phases of the core degradation. This methodology is a straightforward, and fast execution time calculation used to characterize the early phase hydrogen generation in the RT-EVALS evaluations. The hydrogen generation rate evaluation transitions to the late phase hydrogen generation model discussed in LATE PHASE H2 GENERATION.

9. Late Phase H2 Generation

1.0 Background

With the intact fuel assembly configuration and the steam supply from the decay heat generated in the submerged portion of the fuel, the early phase hydrogen generation for a severe core damage event would have the conditions that could lead to a runaway chemical reaction. As discussed in Early Phase H2 Generation, this oxidation reaction is realistically represented as being limited by the extent of steam generated in the water covered part of the core when the upper region is at a sufficiently high temperature for a “steam starvation” condition to exist. Nevertheless, the early phase has a somewhat self-limited nature since the chemical energy released would melt a significant fraction of the core. The downward relocation combined with the subsequent freezing of this molten mass plugs and then destroys the fuel pin configuration and the capability for steam to flow through this region (see FIG. 19).

2.0 Possible Sustained Oxidation During the Late Phase

The oxidation of the unreacted core materials could continue as steam could be circulated around the blocked region(s) to the upper surface of the debris bed where the lighter metallic constituents would likely tend to be concentrated (see FIG. 19). This long term, late phase oxidation behavior was observed in all three Phebus in-reactor experiments (Bourbon et al, 2002, Di Giuli et al, 2015 and Sangiorgi et al, 2015) which demonstrated that hydrogen generation continued at a nearly constant rate for 6000 secs, but at a much lower rate than that consistent with a complete reaction of the steam supplied (a steam starved condition). Moreover, it has been shown (Henry, 2019) that this reduced hydrogen generation is consistent with a natural circulation limitation at which steam could be circulated downward to the debris upper surface in the presence of hydrogen rising from the surface. This natural circulation flow can be characterized by the dimensionless Froude number (NF) associated with the countercurrent volumetric flow rate Q that can be expressed as:

Q/SQRT[Dpow(5)g(Δρ/ρavg)]

or

Q=C0SQRT[Dpow(5)g(Δρ/ρavg)]

where
Δρ=difference between the densities of the steam and hydrogen
ρavg=average of the two gas densities
g=gravitational acceleration and
C0=an empirical coefficient that replaces the Froude number since experiments show this to be a function of the length-to-diameter (L/D) ratio for the natural circulation flow.

FIG. 20 compares the observed hydrogen generation rates in the late phase of core degradation for the three Phebus experiments along with the prediction of the Counter Current Flow Limit of Steam (CCFLS) model to the upper surface of the degraded core material. This model considers that metallic material remains in the compacted core region where it could be circulated within the molten debris to the molten upper surface. If this were to react with steam that could exist above the relocated core debris, then the hydrogen produced would rise and tend to initiate a circulation process that would bring additional steam to the surface. This process would be limited by the condition of equal molar flows of steam flowing down to the surface in the presence of hydrogen rising from the surface. This is the basis of the model predictions shown for the different Phebus tests and the model calculations agree with the magnitude and constant rate of the experimental data for all three tests.

It is to be noted that the Phebus experiments were conducted by injecting steam at a fixed rate into the bottom of the in-reactor test assemblies regardless of the core condition. For a commercial power reactor accident, the compacted core configuration would be the result of molten debris relocating downward into the lower, cooler segments of the reactor core and freezing on these structures. Therefore, the only steam flow that could be produced in this configuration would be a limited amount generated by water vaporization in the lower plenum resulting from radiant heat transfer from the bottom of an overheated core region or some facet of the accident sequence that continues to produce steam that could be circulated through the Reactor Cooling System (RCS).

Considering the broad spectrum of accident conditions, it is possible that the accident sequence could influence the steam partial pressure above the core materials. For example, a Small Break Loss of Coolant Accident (SBLOCA) and the slow RCS depressurization could generate steam that could propagate through the RCS, or the accident could be initiated at an elevated pressure and the early stage of the core damage could be responsible for generating a leakage from the RCS by melting in-core instrumentation for some designs. In this accident progression phase, the steam partial pressure in the region above the degraded could be difficult to determine.

Whatever the accident sequence, a conservative estimate for the late phase oxidation behavior can be developed by assuming a sufficient supply of steam to support countercurrent flow natural circulation with a driving force determined by the density difference between steam and hydrogen at the same temperature as was observed in the three Phebus experiments (see FIG. 20). Part of this conservative estimate should also be to assume that the area for the oxidation behavior is the projected area of the compacted core debris within the constraints of the core geometry. For the Fukushima reactors 1F2 and 1F3, the core had an outer diameter of 3.8 m. This is an area of 11.3 m2 and the denominator of the Froude number for a steam-hydrogen countercurrent flow is 114 m3/s and using a coefficient of 0.05, the calculated volumetric flow rate (Q) is 5.7 m3/s. Using the same steam density that was used in the Phebus analyses (0.2 kg/m3), gives a molar steam flow rate of 63 moles/s to the debris surface and the same value for H2 leaving the surface or 127 g/s (˜0.127 kg/s). This corresponds to 0.0635 kg-mols/s of H2 production and 0.03175 kg-mols/s of Zr reacted which is 2.89 kg/s consumed. The heat of reaction released by this oxidation reaction is 6.8×10E6 J/kg of zirconium reacted (Handbook of Chemistry and Physics, 1972), such that the energy addition rate to the debris would be 19.7 MW. Consequently, the chemical energy addition would be more than twice the decay heat generated in the core debris. To support such an oxidation rate would require a steam supply rate of 1.14 kg/s to the upper plenum and this would require an energy addition rate of about 2.5 MW to water somewhere in the RCS. Any steam addition rate less than this would develop into an equal molar countercurrent flow with the “more dense gas being a mixture of steam and H2 with hydrogen rising from the debris surface. However, if the necessary steam rate would be supplied to the core upper plenum, over an interval of one hour, an additional hydrogen mass of 457 kg would be formed. These limits of uncertainty can be explored by using variations that are a factor of two greater than and less than the 0.05 nominal value. These limits of uncertainty can be explored by using variations that are a factor of two greater than and less than the 0.05 nominal value.

It is also important to consider that the countercurrent flows developed in a reactor system would have a much larger core upper surface area and the L/D should be considered as the order of unity. The coefficient characterizing the countercurrent flow could be somewhat larger than 0.05, perhaps as large as 0.1. However, for a reactor system, the “gas with the greater density” would likely be a mixture of steam and hydrogen and not pure steam as it was for the Phebus experiments.

For the accident evaluation, the major unknown is whether there is a significant flow of steam to the region above the fully degraded core geometry. As was noted in “Early Phase H2 Generation”, for the TMI-2 accident, the core was rapidly covered by water shortly after the early phase of core degradation. While this certainly provided steam to the upper surface, it also rapidly cooled the debris upper surface to form a crust that subsequently impeded the continued oxidation of the unreacted metals in the core. Nevertheless, this did not prevent the molten debris core from finding a relocation path out of the core region and into the water baffle, lower core support, and lower plenum regions. From this it can be deduced that initial cooling of the upper regions of the core debris and the relocation were central to cooling the core debris within the RPV.

10. Non-Nuclear Applications of RT-EVALS

While the concept of the RT-EVALS methodology began in considering how to efficiently use the available plant information in a manner that maximizes the use of the plant resources to counter any event trends that could damage the reactor core, there are two additional applications of this methodology that could be used in some parts of the petro-chemical industry. The first of these is a straightforward application of the methodology to fixed location chemical reactor facilities such as one, or more chemical reactors located within a chemical plant. A second application relates to the monitoring of chemical recipe shipments that are sensitive to changes in the environment (for example the ambient temperature history) and/or the duration of the transportation process.

With the fixed location application, the RT-EVALS methodology could be applied in essentially the same manner that it is for commercial nuclear power plants with the “Core Engineering Module” containing the representation of commercial chemical reaction kinetics that are associated with the specific chemical recipe undergoing a controlled exothermic chemical reaction. Examples of transients of interest would be a loss of cooling to the reaction vessel, an external fire near or around the reaction vessel and other event sequences. For the first transient, the exothermic reaction could enable a continuing increase in the recipe temperature which would accelerate the chemical reaction. The monitoring of the recipe temperature history would provide real time assessments of the reaction behavior, including uncertainty bands on the thermocouple measurements, as well as long term projections of the transient behavior. This would include the possibility that the pressure in the chemical reaction vessel may exceed the lifting pressure of the safety relief valve and discharge some of the recipe into a holding tank or scrubbing system downstream as well as the possibility that vapors and/or non-condensable gases could be released to the environment. For the second event, a fire external to the reaction vessel could potentially cause the recipe reaction rate to increase sufficiently to cause an overpressure in the vessel that would lift the safety relief valve. These processes would be characterized in the “Reactor Coolant System Engineering Module” and the “Containment Engineering Module” for the chemical reaction vessel and the downstream components respectively. For many of these applications, the “Pressurizer Engineering Module” and the “Steam Generator Engineering Module” would not be needed, so these would be bypassed. However, there could be other designs where these would be appropriate for the design. Of course, the “Evaluation Module” and the “Recommendations Actions and Projections of Near Term Behavior” components of the methodology would serve the same purpose that they would be have for commercial nuclear power plants even though the physical processes evaluated in the engineering modules would be specific to the system being considered.

For assessing the safety of a chemical recipe during transportation, RT-EVALS needs to be applied in a manner where the transient behavior of the recipe can be measured and interpreted during the transportation interval. Consequently, the measurements and the evaluation methodology must travel with the chemical recipe. Therefore, the implementation needs to be an on-board computerized hardware instrumentation package that includes a RT-EVALS evaluation methodology for the specific chemical recipe. In transit, the hardware package would continuously monitor the average temperature of the chemical recipe and use the methodology at each measurement interval to provide long term projections of the recipe behavior during the remaining transportation interval, given the status of the recipe (average temperature, the rate of temperature increase and the pressure) at any time. If this assessment results in an average recipe temperature being above the stated allowable temperature for the end of the transport, the evaluation package would transmit an alert along with real time estimates of the time available until the reaction could potential reach a “runaway condition” assuming the current environmental conditions remained unchanged. Along with this, the RT-EVALS evaluations within the hardware would recommend possible actions that could be taken. Each recommendation would be accompanied by an assessment of the long term behavior. Possible candidate actions could be: (i) spraying the external surface of the reaction vessel with water, (ii) quenching the chemical recipe by injection water into the reaction vessel, (iii) quenching the chemical reaction by injecting a chemical retardant, (iv) submerging the reactor vessel in water, (v) depressurizing the reaction vessel before the recipe temperature would reach “runaway conditions” and (vi) emptying the reaction vessel contents into a holding tank if the design permits. Some of these may not be applicable to a given design, but it is likely that more than one could be implemented.

As a result, the RT-EVALS would provide real time projections of the behavior of a chemical recipe during transportation when the reaction kinetics of the recipe (response to temperature and pressure) have been characterized in a laboratory experiment. If the real time projection should result in the recipe average temperature would be greater than the allowable limit before the end of the journey, the RT-EVALS will transmit an “alert” signal and develop a list of possible actions to be taken. RT-EVALS will develop real time projections for each recommended action and part of this assessment needs to be an estimate of the time required to implement a given action. The RT-EVALS enables the operating personnel to manually enter an estimate of the duration from the present time that would be needed to implement a recommended action. Hence, this would be part of the long term evaluations. As long as the average temperature of the chemical recipe remained greater than the safe limit for the end of the transportation, the hardware unit would continue to transmit an “alert” status along with a projection of the time available before a “runaway condition” could be possible if no actions would be taken. Once an action would be taken, the alert would continue to be broadcast with the recognition that an action has been taken and this would project the long term response considering the action taken. In summary, the on-board hardware instrument package, that travels with the chemical recipe, would continuously monitor the recipe average temperature and transmit the status along with real time long term projections of the recipe behavior during the transportation.

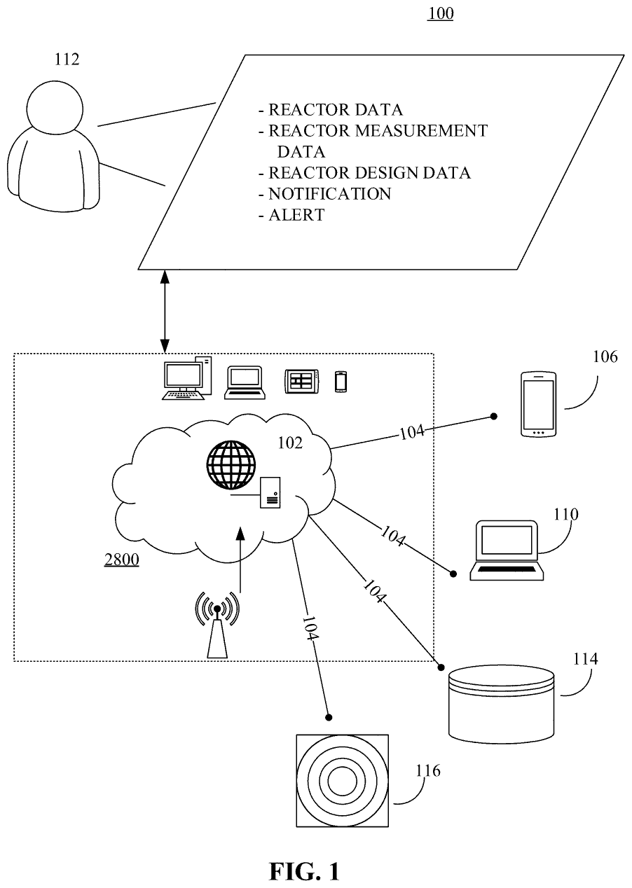

Referring now to figures, FIG. 1 is an illustration of an online platform 100 consistent with various embodiments of the present disclosure. By way of non-limiting example, the online platform 100 to facilitate the management of reactor transient conditions associated with reactors may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 2800.

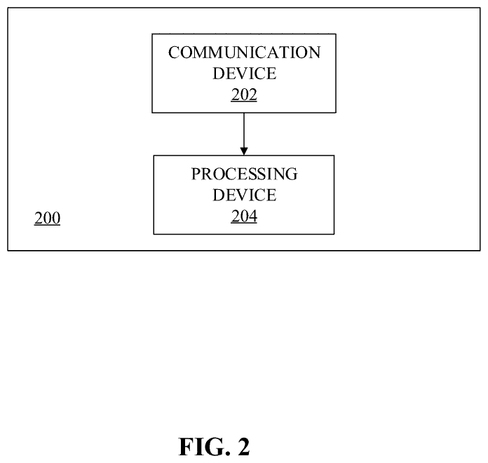

FIG. 2 is a block diagram of a system 200 for facilitating the management of reactor transient conditions associated with reactors in accordance with some embodiments. Accordingly, the system 200 may include a communication device 202 and a processing device 204.

Further, the communication device 202 may be communicatively coupled with a reactor computer associated with a reactor. Further, the communication device 202 may be configured for receiving at least one reactor data associated with the reactor from the reactor computer. Further, the communication device 202 may be configured for receiving a plurality of reactor design data and a plurality of reactor measurement data associated with a plurality of reactor components of the reactor from the reactor computer. Further, the communication device 202 may be configured for transmitting at least one notification to at least one user device associated with at least one user.

Further, the processing device 204 may be configured for determining at least one reactor transient condition associated with the reactor based on the at least one reactor data. Further, the processing device 204 may be configured for analyzing the plurality of reactor design data and the plurality of reactor measurement data. Further, the processing device 204 may be configured for generating the at least one notification corresponding to the at least one reactor transient condition based on the analyzing. Further, the processing device 204 may be configured for developing the at least confirmation of the at least one notification corresponding to the at least one reactor transient condition based on the analyzing.

In further embodiments, the processing device 204 may be configured for analyzing the at least one reactor transient condition. Further, the processing device 204 may be configured for identifying at least one reactor component of the plurality of reactor components based on the analyzing. Further, the communication device 202 may be configured for receiving at least one reactor design data and at least one reactor measurement data corresponding to the at least one reactor component.

In further embodiments, the communication device 202 may be configured for receiving at least one independent reactor measurement data from at least one independent reactor measuring device associated with the plurality of reactor components of the reactor. Further, the communication device 202 may be configured for transmitting at least one confirmatory data to the at least one user device. Further, the processing device 204 may be configured for analyzing the at least one independent reactor measurement data and the at least one reactor transient condition. Further, the processing device 204 may be configured for analyzing the at least one independent reactor measurement data and the at least one reactor transient condition. Further, the processing device 204 may be configured for generating the at least one confirmatory data corresponding to the at least one reactor transient condition based on the analyzing.

In further embodiments, the processing device 204 may be configured for analyzing the at least one reactor transient condition. Further, the processing device 204 may be configured for generating at least one remedial action data corresponding to the at least one reactor transient condition based on the analyzing. Further, the communication device 202 may be configured for transmitting the at least one remedial action data to the at least one user device.

In further embodiments, the communication device 202 may be configured for receiving at least one manual entry associated with at least one reactor component of the plurality of reactor components from the at least one user device. Further, the processing device 204 may be configured for analyzing the plurality of reactor design data, the plurality of reactor measurement data, and the at least one manual entry.

In further embodiments, the communication device 202 may be configured for receiving at least one user control variable associated with the at least one reactor transient condition from the at least one user device. Further, the communication device 202 may be configured for transmitting at least one variable projection to the at least one user device. Further, the processing device 204 may be configured for analyzing the at least one user control variable and the at least one reactor transient condition. Further, the processing device 204 may be configured for generating the at least one variable projection corresponding to the at least one reactor transient condition based on the analyzing.

In further embodiments, the processing device 204 may be configured for determining a plurality of options corresponding to the at least one reactor transient condition. Further, the processing device 204 may be configured for generating at least one alert corresponding to the at least one option. Further, the communication device 202 may be configured for transmitting the plurality of options to the at least one user device. Further, the communication device 202 may be configured for receiving at least one option indication associated with at least one option of the plurality of options from at least one user device. Further, the processing device 204 may be configured for transmitting the at least one alert to at least one external user device associated with at least one external user.

In further embodiments, the communication device 202 may be configured for receiving at least one independent reactor measurement data from at least one independent reactor measuring device associated with the plurality of reactor components of the reactor. Further, the communication device 202 may be configured for transmitting at least one projection to the at least one user device. Further, the processing device 204 may be configured for analyzing the at least one independent reactor measurement data and the at least one reactor transient condition. Further, the processing device 204 may be configured for generating the at least one projection corresponding to the at least one reactor transient condition based on the analyzing.

Further, in some embodiments, the processing device 204 may include at least one engineering module, an evaluation module, and a decision module. Further, the engineering module may be configured for performing at least one engineering evaluation on the plurality of reactor design data and the plurality of reactor measurement data to generate at least one engineering analysis data corresponding to at least one engineering module. Further, the evaluation module may be configured for comparing the at least one engineering analysis data and identifying the at least one reactor transient condition. Further, the decision module may be configured for generating a plurality of options based on the at least one reactor transient condition.

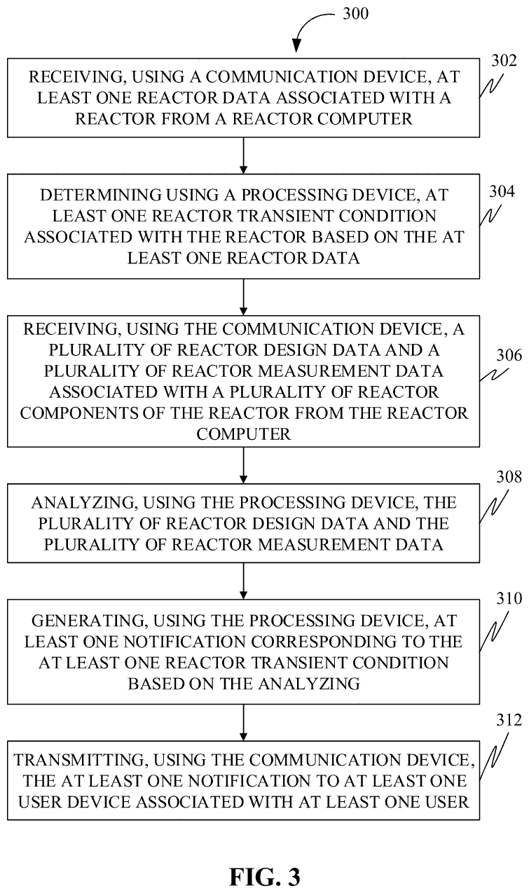

FIG. 3 is a flowchart of a method 300 for facilitating the management of reactor transient conditions associated with reactors, in accordance with some embodiments. Accordingly, at 302, the method 300 may include a step of receiving, using a communication device (such as the communication device 202), at least one reactor data associated with a reactor from a reactor computer. Further, the at least one reactor data may facilitate determination of a functional state associated with the reactor. Further, the reactor computer may include a computing device such as laptop, a personal computer, and so on.

Further, at 304, the method 300 may include a step of determining, using a processing device (such as the processing device 204), at least one reactor transient condition associated with the reactor based on the at least one reactor data. Further, the at least one reactor transient condition may refer to loss of load, loss off-site power, etc.

Further, at 306, the method 300 may include a step of receiving, using the communication device, a plurality of reactor design data and a plurality of reactor measurement data associated with a plurality of reactor components of the reactor from the reactor computer. Further, the plurality of reactor design data may include dimensions, designed pump flow rates, maximum power generation, etc. associated with the reactor. Further, the plurality of reactor design data may include maximum designed core operating power, reactor nuclear fuel assembly dimensions, number of assemblies, etc. Further, the plurality of rector measurement data may include core power, central rod position, system pressure, tailpipe temperature, etc.

Further, at 308, the method 300 may include a step of analyzing, using the processing device, the plurality of reactor design data and the plurality of reactor measurement data.

Further, at 310, the method 300 may include a step of generating, using the processing device, at least one notification corresponding to the at least one reactor transient condition based on the analyzing. Further, the at least one notification may facilitate the identification of the at least one reactor transient condition. Further, the at least one notification may include a textual content associated with the at least one reactor transient condition.

In some embodiments, the method 300 may include a step of generating confirmation of a notification corresponding to the reactor transient condition based on the analyzing.

Further, at 312, the method 300 may include a step of transmitting, using the communication device, the at least one notification to at least one user device associated with at least one user. Further, the at least one user may include an individual, an institution, and an organization that may want to receive the at least one notification corresponding to the at least one reactor transient condition. Further, at 312, the method 300 may include a step of transmitting, using the communication device, the confirmation to at least one user device associated with at least one user.

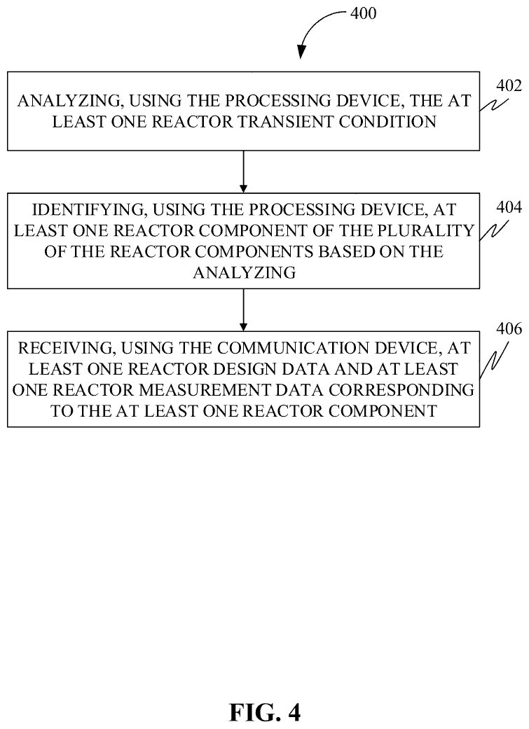

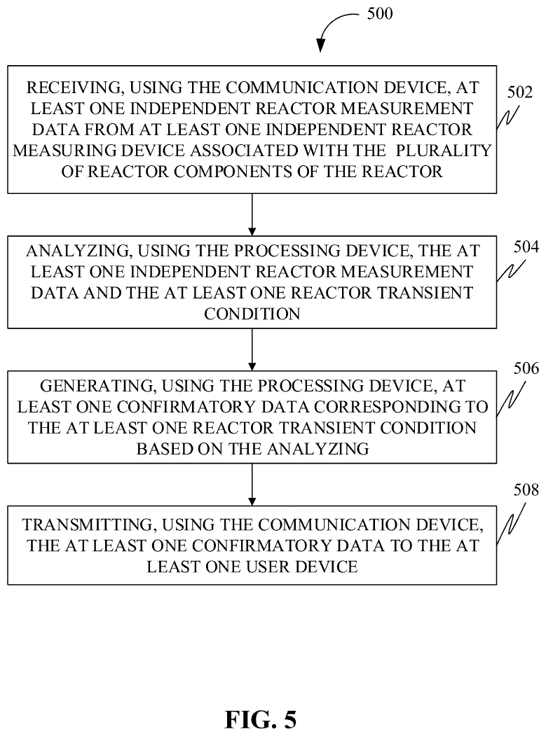

FIG. 4 is a flowchart of a method 400 for facilitating identification of reactor component based on analyzing transient condition, in accordance with some embodiments. Accordingly, at 402, the method 400 may include a step of analyzing, using the processing device, at least one reactor transient condition.

Further, at 404, the method 400 may include a step of identifying, using the processing device, at least one reactor component of the plurality of the reactor components based on the analyzing.

Further, at 406, the method 400 may include a step of receiving, using the communication device, at least one reactor design data and at least one reactor measurement data corresponding to the at least one reactor component.

FIG. 5 is a flowchart of a method 500 for facilitating the generation of confirmation data corresponding to the reactor transient condition, in accordance with some embodiments. Accordingly, at 502, the method 500 may include a step of receiving, using the communication device, at least one independent reactor measurement data from at least one independent reactor measuring device associated with the plurality of reactor components of the reactor.

Further, at 504, the method 500 may include a step of analyzing, using the processing device, the at least one independent reactor measurement data and the at least one reactor transient condition.

Further, at 506, the method 500 may include a step of generating, using the processing device, at least one confirmatory data corresponding to the at least one reactor transient condition based on the analyzing.

Further, at 508, the method 500 may include a step of transmitting, using the communication device, the at least one confirmatory data to the at least one user device.

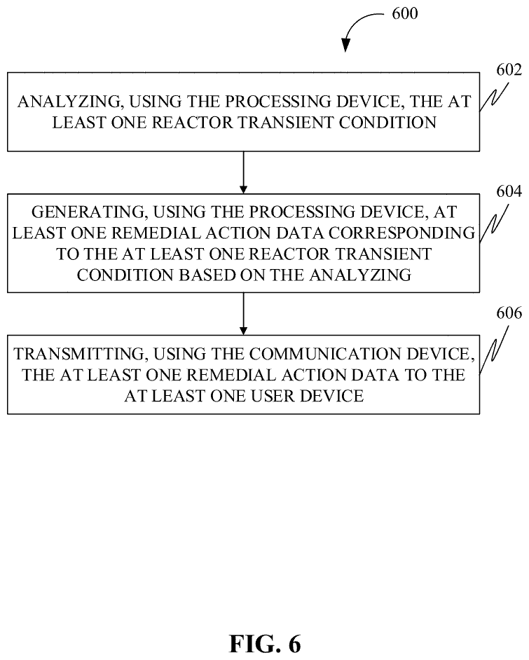

FIG. 6 is a flowchart of a method for facilitating the generation of remedial action corresponding to the reactor transient condition, in accordance with some embodiments. Accordingly, at 602, the method 600 may include a step of analyzing, using the processing device, the at least one reactor transient condition.

Further, at 604, the method 600 may include a step of generating, using the processing device, at least one remedial action data corresponding to the at least one reactor transient condition based on the analyzing.

Further at 606, the method 600 may include a step of transmitting, using the communication device, the at least one remedial action data to the at least one user device.

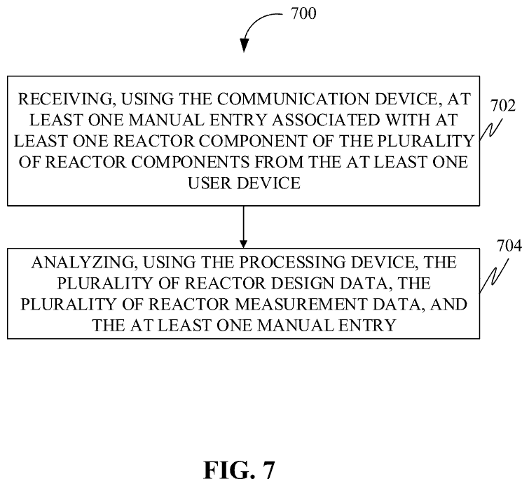

FIG. 7 is a flowchart of a method 700 for facilitating analyzing of reactor design data, reactor measurement data, and manual entry, in accordance with some embodiments. Accordingly, at 702, the method 700 may include a step of receiving, using the communication device, at least one manual entry associated with at least one reactor component of the plurality of reactor components from the at least one user device.

Further, at 704, the method 700 may include a step of analyzing, using the processing device, the plurality of reactor design data, the plurality of reactor measurement data, and the at least one manual entry.

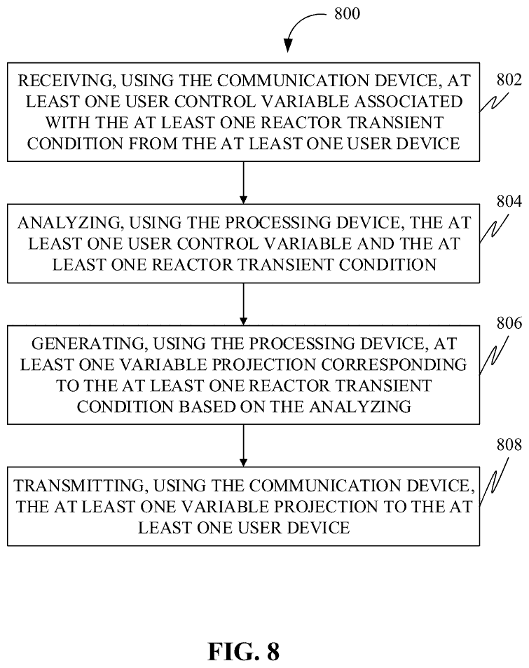

FIG. 8 is a flowchart of a method 800 for facilitating the generation of variable projection corresponding to the reactor transient condition, in accordance with some embodiments. Accordingly, at 802, the method 800 may include a step of receiving, using the communication device, at least one user control variable associated with the at least one reactor transient condition from the at least one user device.

Further, at 804, the method 800 may include a step of analyzing, using the processing device, the at least one user control variable and the at least one reactor transient condition.

Further, at 806, the method 800 may include a step of generating, using the processing device, at least one variable projection corresponding to the at least one reactor transient condition based on the analyzing.

Further, at 808, the method 800 may include a step of transmitting, using the communication device, the at least one variable projection to the at least one user device.

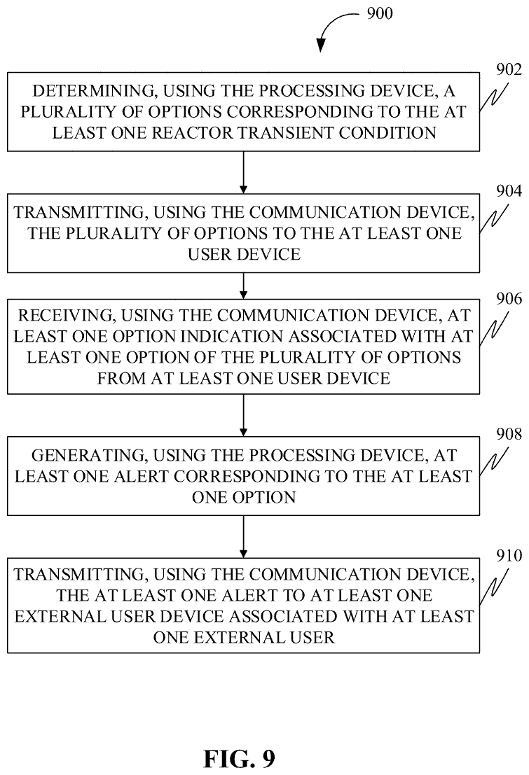

FIG. 9 is a flowchart of a method 900 for facilitating the generation of an alert, in accordance with some embodiments. Accordingly, at 902, the method 900 may include a step of determining, using the processing device, a plurality of options corresponding to the at least one reactor transient condition.

Further, at 904, the method 900 may include a step of transmitting, using the communication device, the plurality of options to the at least one user device.

Further, at 906, the method 900 may include a step of receiving, using the communication device, at least one option indication associated with at least one option of the plurality of options from at least one user device.

Further, at 908, the method 900 may include a step of generating, using the processing device, at least one alert corresponding to the at least one option.

Further, at 910, the method 900 may include a step of transmitting, using the communication device, the at least one alert to at least one external user device associated with at least one external user.

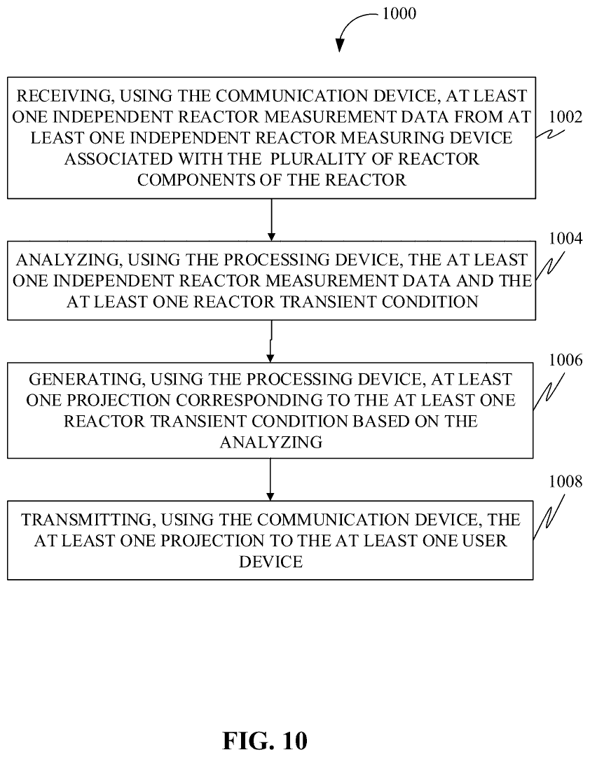

FIG. 10 is a flowchart of a method 1000 for facilitating the generation of projection corresponding to the reactor transient condition, in accordance with some embodiments. Accordingly, at 1002, the method 1000 may include a step of receiving, using the communication device, at least one independent reactor measurement data from at least one independent reactor measuring device associated with the plurality of reactor components of the reactor.

Further, at 1004, the method 1000 may include a step of analyzing, using the processing device, the at least one independent reactor measurement data and the at least one reactor transient condition.

Further, at 1006, the method 1000 may include a step of generating, using the processing device, at least one projection corresponding to the at least one reactor transient condition based on the analyzing.

Further, at 1008, the method 1000 may include a step of transmitting, using the communication device, the at least one projection to the at least one user device.

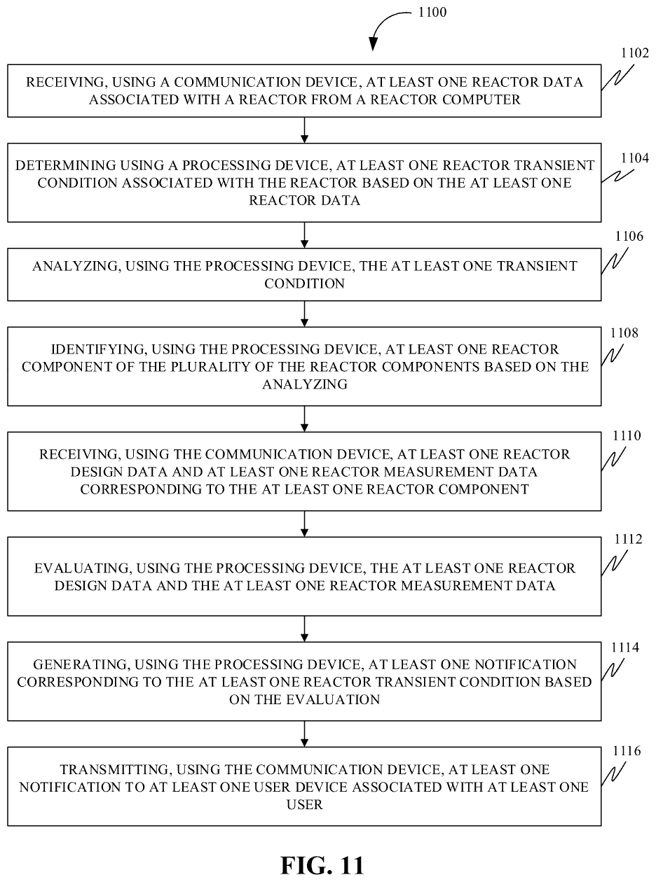

FIG. 11 is a flowchart of a method 1100 for facilitating the management of reactor transient conditions associated with reactors, in accordance with some embodiments. Accordingly, at 1102, the method 1100 may include a step of receiving, using a communication device, at least one reactor data associated with a reactor from a reactor computer. Further, the reactor may include a plurality of reactor components.

Further, at 1104, the method 1100 may include a step of determining, using a processing device, at least one reactor transient condition associated with the reactor based on the at least one reactor data.

Further, at 1106, the method 1100 may include a step of analyzing, using the processing device, the at least one reactor transient condition.

Further, at 1108, the method 1100 may include a step of identifying, using the processing device, at least one reactor component of the plurality of the reactor components based on the analyzing.

Further, at 1110, the method 1100 may include a step of receiving, using the communication device, at least one reactor design data and at least one reactor measurement data corresponding to the at least one reactor component.

Further, at 1112, the method 1100 may include a step of evaluating, using the processing device, the at least one reactor design data and the at least one reactor measurement data.

Further, at 1114, the method 1100 may include a step of generating, using the processing device, at least one notification corresponding to the at least one reactor transient condition based on the evaluation

Further, at 1116, the method 1100 may include a step of transmitting, using the communication device, at least one notification to at least one user device associated with at least one user.

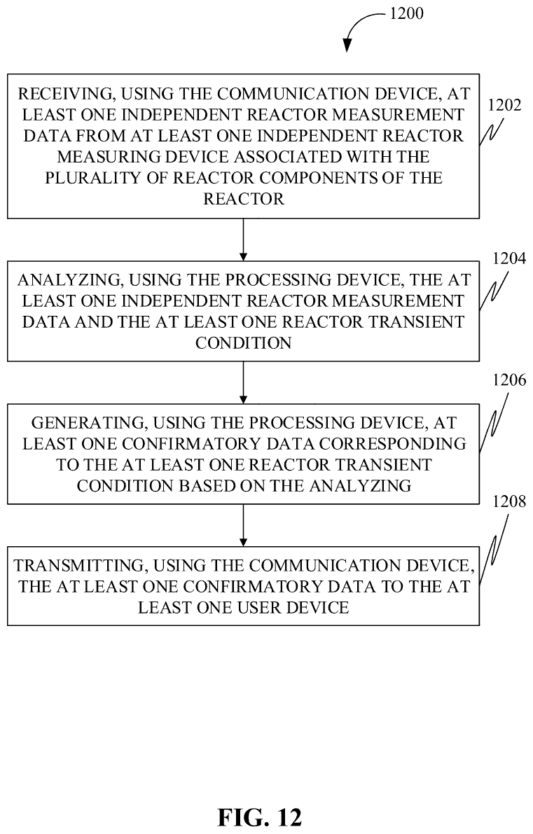

FIG. 12 is a flowchart of a method 1200 for facilitating the generation of confirmatory data corresponding to the reactor transient condition, in accordance with some embodiments. Accordingly, at 1202, the method 1200 may include a step of receiving, using the communication device, at least one independent reactor measurement data from at least one independent reactor measuring device associated with the plurality of reactor components of the reactor.

Further, at 1204, the method 1200 may include a step of analyzing, using the processing device, the at least one independent reactor measurement data and the at least one reactor transient condition.

Further, at 1206, the method 1200 may include a step of generating, using the processing device, at least one confirmatory data corresponding to the at least one reactor transient condition based on the analyzing.

Further, at 1208, the method 1200 may include a step of transmitting, using the communication device, the at least one confirmatory data to the at least one user device.

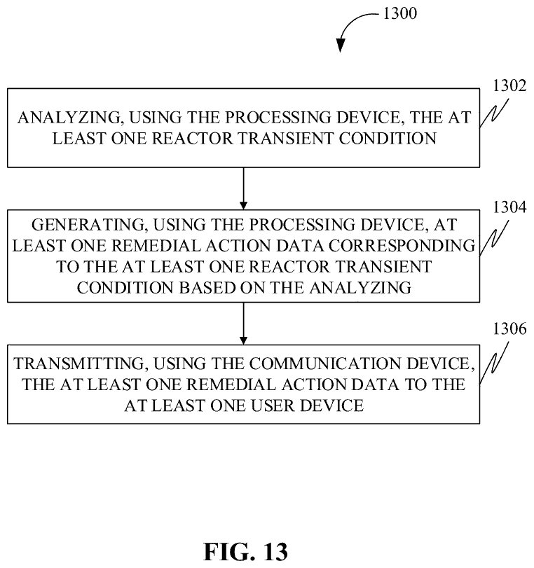

FIG. 13 is a flowchart of a method 1300 for facilitating the generation of remedial action corresponding to the reactor transient condition, in accordance with some embodiments. Accordingly, at 1302, the method 1300 may include a step of analyzing, using the processing device, the at least one reactor transient condition.

Further, at 1304, the method 1300 may include a step of generating, using the processing device, at least one remedial action data corresponding to the at least one reactor transient condition based on the analyzing.

Further, at 1306, the method 1300 may include a step of transmitting, using the communication device, the at least one remedial action data to the at least one user device.

FIG. 14 is a perspective view of the TMI-2 containment building 1400, in accordance with prior art. Accordingly, the containment building may include at least one component such as reactor vessel 1410, the “B” steam generator 1408, the “A” steam generator 1412, reactor coolant pump 1406, pressurizer 1414, core flood tank 1404, reactor building sump 1402, reactor coolant drain tank 1416, etc. Further, the pressurizer 1414 may include safety relief valves as well as a Pilot Operated Relief Valve (PORV) at the top. Further, the system may examine the behavior of the at least one component upon occurrence of the reactor transient condition. Further, the at least one component may have large, leak-tight containment building.

FIG. 15 is a flow diagram 1500 of operations for engineering modules, decision module 1514 and evaluation module 1508, in accordance with some embodiments. Accordingly, the engineering module may include a core module 1502, a Reactor Coolant System (RCS) module 1504, Pressurizer (PZR) module 1506, Steam Generator (SG) module 1510, Containment module 1512. Further, at least one major data source may include plant design information and plant computer measurements. Further, arrows 1516-1528 may indicate the distribution of the plant design information base. Further, arrows 1530-1544 may indicate distribution of the plant computer measurements. Further, methodology may provide a means of including information that may be recorded by another system, or manually recorded that are meaningful measurements for characterizing the transient behavior. This information may be indicated by the arrows 1546-1558 and this data entry path may provide a means of incorporating measurements that may only be used during maintenance activities and/or refueling.

FIG. 16 is a block diagram 1600 of submodules of Reactor Coolant System (RCS) and Pressurizer (PZR), in accordance with some embodiments. Further, the block diagram may include accumulators (such as nitrogen pressurized water accumulators) 1602 that are on each cold leg and Emergency Core Cooling Systems (ECCS) 1604 as well as the water injection systems that take suction from the Refueling Water Storage Tank (RWST) 1606.

FIG. 17 is a block diagram 1700 of submodule of the containment module 1512, in accordance with some embodiments. Further, the containment module 1512 may include condensate storage tank 1702, air fan coolers 1704, room coolers 1706, etc.

FIG. 18 is a graphical representation 1800 showing the comparison of the Average Core Void Fraction (u) from the SRM signal using the approach discussed by Hooker and Popper (1958) with the boil-down of the TMI-2 core water level, in accordance with some embodiments. Accordingly, the increasing Source Range Monitors (SRM) signal may be compared with representations using the radiation attenuation approach recommended by Hooker and Popper (1958) with the decreasing core water level calculated by the steam generated as a result of decay heat generated beneath the water level. As shown by the close comparison between the SRM measurement signal and the calculated behavior, if the reactor is scrammed, the core average steam void fraction may be closely estimated using the recorded SRM signal. Clearly, once a void may be detected in the core, the Reactor Coolant System (RCS) has lost some of its water inventory, which may be a Loss of Coolant Accident (LOCA). This estimated void fraction value may be transmitted to the Evaluation Module where it is compared to the results of calculations from the RCS Module, the Pressurizer (PZR) Module and the Containment Module that may provide insights into where a LOCA site could exist as well as confirmation of steam formation in the RCS and/or an increase in the steam partial pressure in the containment.

FIG. 19 is a schematic 1900 of core degradation in the Phebus in reactor experiments and the flow of steam through and around the core, in accordance with some embodiments. Accordingly, the oxidation of the unreacted core materials could continue as steam could be circulated around the blocked region(s) to the upper surface of the debris bed where the lighter metallic constituents would likely tend to be concentrated (see FIG. 6). This long term, late phase oxidation behavior was observed in all three Phebus in-reactor experiments (Bourbon et al, 2002, Di Giuli et al, 2015 and Sangiorgi et al, 2015) which demonstrated that hydrogen generation continued at a nearly constant rate for 6000 secs, but at a much lower rate than that consistent with a complete reaction of the steam supplied (a steam starved condition). Moreover, it has been shown (Henry, 2019) that this reduced hydrogen generation is consistent with a natural circulation limitation at which steam could be circulated downward to the debris upper surface in the presence of hydrogen rising from the surface. This natural circulation flow can be characterized by the dimensionless Froude number (NF) associated with the countercurrent volumetric flow rate Q that can be expressed as:

NF=Q/SQRT[Dpow(5)g(Δρ/ρavg)]

or

Q=C0SQRT[Dpow(5)g(Δρ/ρavg)]

Where, Δρ=difference between the densities of the steam and hydrogen

ρavg=average of the two gas densities
g=gravitational acceleration and
C0=an empirical coefficient that replaces the Froude number since experiments show this to be a function of the length-to-diameter (L/D) ratio for the natural circulation flow.

FIG. 20 is a graphical representation 2000 of measured hydrogen generation for three Phebus experiments and the comparison of measured late phase generation rate with the Countercurrent Flow Late Stage (CCFLS) Model, in accordance with some embodiments. Accordingly, the graphical representation may be observed in all three tests that there is a maximum generation rate that characterizes the early phase of oxidation when the fuel pin geometry is intact. Subsequently, the rate of hydrogen generation suddenly decreases to a much slower rate that is well predicted by the natural circulation of steam downward to the debris upper surface shown by the black lines that illustrate the results of the CCFLS model presented in the Henry (2019) reference. Further, the system, RT-EVALS uses this late stage model in the Core Module to assess the hydrogen generate that could persist during that late stage of an accident that would occur if a severe core damage event were to progress to the late stage. Further, the Counter Current Flow Limit of Steam (CCFLS) model may consider that metallic material remains in the compacted core region where it could be circulated to the molten upper surface. If this were to react with steam that could exist above the core, then the hydrogen produced would rise and tend to initiate a circulation process that would bring additional steam to the surface. This process would be limited by the condition of equal molar flows of steam flowing down to the surface in the presence of hydrogen rising from the surface. This is the basis of the model predictions shown for the different Phebus tests and the model calculations agree with the magnitude and constant rate of the experimental data for all three tests.

FIG. 21 is a graphical representation 2100 of measured steam voids in the core and Reactor Coolant System (RCS) for the TMI-2 Event, in accordance with some embodiments. Accordingly, the graphical representation 2100 may be observed that these may not be in perfect agreement, but they don't need to be since both core and Reactor Coolant System (RCS) indicate a large steam void was developing in the core and is confirmed by the RCS loop mass flow rate measurements. Neither of these instruments was intended to be a void meter and they aren't even in the same location. However, each provides a first order estimate of the average void fraction and these both indicate that a troublesome situation was evolving. This is confirmation of the fact that water is being lost from the RCS and is a developing challenge to reactor core.

FIG. 22 is a graphical representation 2200 of comparison of the TMI-2 pressurizer water level measurement and the calculation of the level swell needed for the PORV to vent a steam-water mixture, in accordance with some embodiments. Accordingly, the graphical representation 2200 may indicate that the level swell evaluation compares well with the measurement once the pressure became relatively constant at 1000 seconds. This sustained water level indication in the PZR is, by itself, an important result indicating a continuous discharge of a steam-water mixture from the top of the PZR. This behavior results naturally from the affected pressurizer and this information is supplied to the Evaluation Module by the PZR Engineering Module as an important first order result to be confirmed by other measurements.

FIG. 23 is a graphical representation 2300 of comparison of Reactor Coolant Drain Tank (RCDT) and Reactor Coolant System (RCS) Pressures and temperature compensated PZR water level histories for the TMI-2 accident along with the calculated RCDT history, in accordance with some embodiments. Accordingly, the recorded trace of “Drain Tank Pressure” shows a significant pressure increase within the first three minutes of the plant transient. (Note from the “Primary System Pressure” shown in FIG. 23, the Pilot Operated Relief Valve (PORV) should have reset after about 10 seconds of lifting. Thus, the extended flow through the tailpipe should not occur if the system performed as designed.) The strip chart with this information was in a cabinet behind the main control cabinets and was not observed by the control room operators. However, if this information was available on the plant computer, this pressurization could be accessed and compared to the data from the other instruments and within the first three minutes there would have been a realization of a sustained high PZR level that would have concluded a stuck open valve was discharging the primary coolant water to the containment. In the RT-EVALS methodology this RCDT pressurization history may increase the depth of independent confirmation to that already obtained from tailpipe temperatures.

Further, the graphical representation 2300 may show the results (gray dots) of the calculated pressurization assuming the PZR PORV is stuck open and with a steam-water mixture discharging into the drain tank that is half full of water. This simple calculation, which may be performed much faster than real time, is in good agreement with the measured behavior. Consequently, the discharge flow rate may be estimated from the measured pressurization rate if it was needed. In summary, what this RT-EVALS methodology accomplishes is the immediate usage of all the relevant information to detect an evolving challenge and determine the depth of confirmation of the conclusion. This may be accomplished through straightforward calculations that may be executed essentially as rapidly as the data may be available from the plant computer.

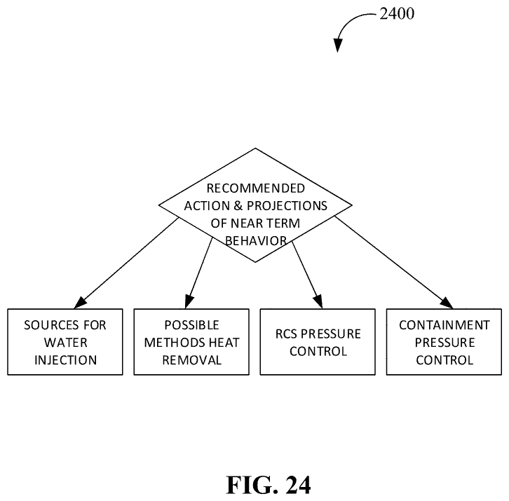

FIG. 24 is a schematic 2400 of possible actions associated with decision block, in accordance with some embodiments. Further, the decisional block may take decisions associated with the sources for water injections, methods of heat removal, Reactor Presssure Control (RCS) pressure control, containment pressure control, etc.

FIG. 25 is a tabular representation 2500 of a TMI-2 pressurizer response immediately following a trip of the main feed water pumps, in accordance with some embodiments.

FIG. 26 is a tabular representation 2600 of the comparison of comparison of measured and calculated tailpipe pipe temperatures for the TMI-2 accident, in accordance with some embodiments.

FIG. 27 is a tabular representation 2700 of timing of water depletion in a reactor core and the resulting overheating of fuel pins by decay heat and cladding oxidation, in accordance with some embodiments.

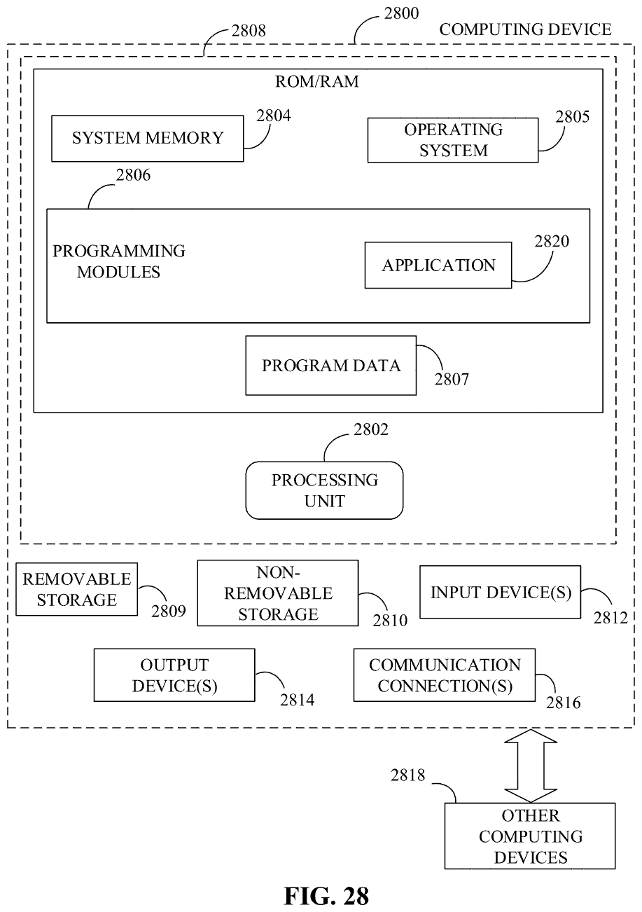

With reference to FIG. 28, a system consistent with an embodiment of the disclosure may include a computing device or cloud service, such as computing device 2800. In a basic configuration, computing device 2800 may include at least one processing unit 2802 and a system memory 2804. Depending on the configuration and type of computing device, system memory 2804 may comprise, but is not limited to, volatile (e.g. random-access memory (RAM)), non-volatile (e.g. read-only memory (ROM)), flash memory, or any combination. System memory 2804 may include operating system 2805, one or more programming modules 2806, and may include a program data 2807. Operating system 2805, for example, may be suitable for controlling computing device 2800's operation. In one embodiment, programming modules 2806 may include image-processing module, machine learning module. Furthermore, embodiments of the disclosure may be practiced in conjunction with a graphics library, other operating systems, or any other application program and is not limited to any particular application or system. This basic configuration is illustrated in FIG. 28 by those components within a dashed line 2808.

Computing device 2800 may have additional features or functionality. For example, computing device 2800 may also include additional data storage devices (removable and/or non-removable) such as, for example, magnetic disks, optical disks, or tape. Such additional storage is illustrated in FIG. 28 by a removable storage 2809 and a non-removable storage 2810. Computer storage media may include volatile and non-volatile, removable and non-removable media implemented in any method or technology for storage of information, such as computer-readable instructions, data structures, program modules, or other data. System memory 2804, removable storage 2809, and non-removable storage 2810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2800. Any such computer storage media may be part of device 2800. Computing device 2800 may also have input device(s) 2812 such as a keyboard, a mouse, a pen, a sound input device, a touch input device, a location sensor, a camera, a biometric sensor, etc. Output device(s) 2814 such as a display, speakers, a printer, etc. may also be included. The aforementioned devices are examples and others may be used.

Computing device 2800 may also contain a communication connection 2816 that may allow device 2800 to communicate with other computing devices 2818, such as over a network in a distributed computing environment, for example, an intranet or the Internet. Communication connection 2816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2804, including operating system 2805. While executing on processing unit 2802, programming modules 2806 (e.g., application 2820 such as a media player) may perform processes including, for example, one or more stages of methods, algorithms, systems, applications, servers, databases as described above. The aforementioned process is an example, and processing unit 2802 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies.

In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

1. A system for facilitating the management of reactor transient conditions associated with reactors, the system comprising:
a communication device communicatively coupled with a reactor computer associated with a reactor, wherein the communication device is configured for:
receiving at least one reactor data associated with the reactor from the reactor computer;
receiving a plurality of reactor design data and a plurality of reactor measurement data associated with a plurality of reactor components of the reactor from the reactor computer;
transmitting at least one notification to at least one user device associated with at least one user;
a processing device configured for:
determining at least one reactor transient condition associated with the reactor based on the at least one reactor data;
analyzing the plurality of reactor design data and the plurality of reactor measurement data; and
generating the at least one notification corresponding to the at least one reactor transient condition based on the analyzing.

2. The system of claim 1 further comprising:
the processing device configured for:
analyzing the at least one transient condition;
identifying at least one reactor component of the plurality of reactor components based on the analyzing; and
the communication device is configured for receiving at least one reactor design data and at least one reactor measurement data corresponding to the at least one reactor component.

3. The system of claim 1 further comprising:
the communication device configured for:
receiving at least one independent reactor measurement data from at least one independent reactor measuring device associated with the plurality of reactor components of the reactor;
transmitting at least one confirmatory data to the at least one user device;
the processing device configured for:
analyzing the at least one independent reactor measurement data and the at least one reactor transient condition; and
generating the at least one confirmatory data corresponding to the at least one reactor transient condition based on the analyzing.

4. The system of claim 1 further comprising:
the processing device configured for:
analyzing the at least one reactor transient condition;
generating at least one remedial action data corresponding to the at least one reactor transient condition based on the analyzing; and
the communication device is configured for transmitting the at least one remedial action data to the at least one user device.

5. The system of claim 1 further comprising:
the communication device configured for receiving at least one manual entry associated with at least one reactor component of the plurality of reactor components from the at least one user device; and
the processing device configured for analyzing the plurality of reactor design data, the plurality of reactor measurement data, and the at least one manual entry.

6. The system of claim 1 further comprising:
the communication device configured for:
receiving at least one user control variable associated with the at least one reactor transient condition from the at least one user device;
transmitting at least one variable projection to the at least one user device;
the processing device configured for:
analyzing the at least one user control variable and the at least one reactor transient condition; and
generating the at least one variable projection corresponding to the at least one reactor transient condition based on the analyzing.

7. The system of claim 1 further comprising:
the processing device configured for:
determining a plurality of options corresponding to the at least one reactor transient condition;
generating at least one alert corresponding to the at least one option;
the communication device is configured for:
transmitting the plurality of options to the at least one user device;
receiving at least one option indication associated with at least one option of the plurality of options from at least one user device; and
transmitting the at least one alert to at least one external user device associated with at least one external user.

8. The system of claim 1 further comprising:
the communication device configured for:
receiving at least one independent reactor measurement data from at least one independent reactor measuring device associated with the plurality of reactor components of the reactor;
transmitting at least one projection to the at least one user device;
the processing device configured for:
analyzing the at least one independent reactor measurement data and the at least one reactor transient condition; and
generating the at least one projection corresponding to the at least one reactor transient condition based on the analyzing.

9. The system of claim 1, wherein the processing device comprises at least one engineering module, an evaluation module, and a decision module, wherein the engineering module is configured for performing at least one engineering evaluation on the plurality of reactor design data and the plurality of reactor measurement data to generate at least one engineering analysis data corresponding to at least one engineering module, wherein the evaluation module is configured for comparing the at least one engineering analysis data and identifying the at least one reactor transient condition, wherein the decision module is configured for generating a plurality of options based on the at least one reactor transient condition.

10. A method for facilitating the management of reactor transient conditions associated with reactors, the method comprising:
receiving, using a communication device, at least one reactor data associated with a reactor from a reactor computer;
determining using a processing device, at least one reactor transient condition associated with the reactor based on the at least one reactor data;
receiving, using the communication device, a plurality of reactor design data and a plurality of reactor measurement data associated with a plurality of reactor components of the reactor from the reactor computer;
analyzing, using the processing device, the plurality of reactor design data and the plurality of reactor measurement data;
generating, using the processing device, at least one notification corresponding to the at least one reactor transient condition based on the analyzing; and
transmitting, using the communication device, the at least one notification to at least one user device associated with at least one user.

11. The method of claim 1 further comprising:
analyzing, using the processing device, the at least one transient condition;
identifying, using the processing device, at least one reactor component of the plurality of the reactor components based on the analyzing; and
receiving, using the communication device, at least one reactor design data and at least one reactor measurement data corresponding to the at least one reactor component.

12. The method of claim 1 further comprising:
receiving, using the communication device, at least one independent reactor measurement data from at least one independent reactor measuring device associated with the plurality of reactor components of the reactor;
analyzing, using the processing device, the at least one independent reactor measurement data and the at least one reactor transient condition;
generating, using the processing device, at least one confirmatory data corresponding to the at least one reactor transient condition based on the analyzing; and
transmitting, using the communication device, the at least one confirmatory data to the at least one user device.

13. The method of claim 1 further comprising:
analyzing, using the processing device, the at least one reactor transient condition;
generating, using the processing device, at least one remedial action data corresponding to the at least one reactor transient condition based on the analyzing; and
transmitting, using the communication device, the at least one remedial action data to the at least one user device.

14. The method of claim 1 further comprising:
receiving, using the communication device, at least one manual entry associated with at least one reactor component of the plurality of reactor components from the at least one user device; and
analyzing, using the processing device, the plurality of reactor design data, the plurality of reactor measurement data, and the at least one manual entry.

15. The system of claim 1 further comprising:
receiving, using the communication device, at least one user control variable associated with the at least one reactor transient condition from the at least one user device;
analyzing, using the processing device, the at least one user control variable and the at least one reactor transient condition;
generating, using the processing device, at least one variable projection corresponding to the at least one reactor transient condition based on the analyzing; and
transmitting, using the communication device, the at least one variable projection to the at least one user device.

16. The method of claim 1 further comprising:
determining, using the processing device, a plurality of options corresponding to the at least one reactor transient condition;
transmitting, using the communication device, the plurality of options to the at least one user device;
receiving, using the communication device, at least one option indication associated with at least one option of the plurality of options from at least one user device;
generating, using the processing device, at least one alert corresponding to the at least one option; and
transmitting, using the communication device, the at least one alert to at least one external user device associated with at least one external user.

17. The method of claim 1 further comprising:
receiving, using the communication device, at least one independent reactor measurement data from at least one independent reactor measuring device associated with the plurality of reactor components of the reactor;
analyzing, using the processing device, the at least one independent reactor measurement data and the at least one reactor transient condition;
generating, using the processing device, at least one projection corresponding to the at least one reactor transient condition based on the analyzing; and
transmitting, using the communication device, the at least one projection to the at least one user device.

18. A method for facilitating the management of reactor transient conditions associated with reactors, the method comprising:
receiving, using a communication device, at least one reactor data associated with a reactor from a reactor computer, wherein the reactor comprises a plurality of reactor components;
determining using a processing device, at least one reactor transient condition associated with the reactor based on the at least one reactor data;
analyzing, using the processing device, the at least one transient condition;
identifying, using the processing device, at least one reactor component of the plurality of the reactor components based on the analyzing;
receiving, using the communication device, at least one reactor design data and at least one reactor measurement data corresponding to the at least one reactor component;
evaluating, using the processing device, the at least one reactor design data and the at least one reactor measurement data;
generating, using the processing device, at least one notification corresponding to the at least one reactor transient condition based on the evaluation; and
transmitting, using the communication device, at least one notification to at least one user device associated with at least one user.

19. The method of claim 18 further comprising:
receiving, using the communication device, at least one independent reactor measurement data from at least one independent reactor measuring device associated with the plurality of reactor components of the reactor;
analyzing, using the processing device, the at least one independent reactor measurement data and the at least one reactor transient condition;
generating, using the processing device, at least one confirmatory data corresponding to the at least one reactor transient condition based on the analyzing; and
transmitting, using the communication device, the at least one confirmatory data to the at least one user device.

20. The method of claim 18 further comprising:
analyzing, using the processing device, the at least one reactor transient condition;
generating, using the processing device, at least one remedial action data corresponding to the at least one reactor transient condition based on the analyzing; and
transmitting, using the communication device, the at least one remedial action data to the at least one user device.
